(19) United States
(12) Patent Application Publication
(10) Pub. No.: US 2005/0238932 A1
(43) Pub. Date: Oct. 27, 2005

(54) Fuel cell power source, method of operating thereof and portable electronic equipment

(76) Inventors: Tooru Koyama, Hitachi (JP); Osamu Kubota, Hitachi (JP); Hidetoshi Honbou, Hitachinaka (JP); Kenichi Souma, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/074,058

(22) Filed: Mar. 8, 2005

(30) Foreign Application Priority Data
Jul. 15, 2004 (JP) 2004-207996
Apr. 26, 2004 (JP) 2004-130274

(51) Int. Cl. H01M 8/00

(52) U.S. Cl. 429/13; 429/30; 429/40

(57) ABSTRACT

A fuel cell power source is provided with a means for feeding a liquid fuel cell and water through time-sharing with the use of a single pump so as to maintain concentration of the liquid fuel, thereby it is possible to decrease the number of accessories in order to reduce the size of the fuel cell power source and as well to reduce the costs.

### BACKGROUND OF THE INVENTION

The present invention relates to a fuel cell power source using a liquid such as methanol as a fuel, a method of operating thereof and a portable electronic equipment using the fuel cell power source.

With the recent development of electronic technologies, portable electronic equipments such as cellular phones, laptop computers, audio-visual equipments, personal digital assistants and the like have become small-sized, and have been rapidly and widely spread. Conventionally, such portable electronic equipments have been operated by a secondary battery. This secondary battery has been also developed so that a seal lead battery, a nickel/cadmium (Ni/Cd) battery, a nickel/hydrogen (Ni/MH) battery and a Lithium (Li) ion secondary battery have been used with time in the mentioned order. That is, the secondary battery has been developed and widely spread since the miniaturization and the high energy density have been attained. As to any of the above-mentioned secondary batteries, it has been attempted to prolong the serviceable time of the secondary battery per charging through development of a battery activating substance and development of the structure of a high capacity battery.

However, these secondary batteries have to be charged after a predetermined volume of power is consumed, and accordingly, it requires charging equipment and a relatively long charging time. Thus, there has been raised a problem in the case of long time operation of a portable electronic equipment using a secondary battery. Further, portable electronic equipments have to rapidly accept information capacity and high speed processing which will be increased in future, and accordingly, there has been required a power source which has a higher output power density and a higher energy density, and which can be continuously used for a long time. There has been great attention to a fuel cell which can make power generation by itself without the necessity of charging so as to achieve the above-mentioned demands. The fuel cell can directly convert a chemical energy owned by a fuel into an electric energy through electrochemical reaction, and accordingly, it has such a feature that its energy efficiency is high. Further, the fuel cell can continue its power generation only by replacing or refilling the fuel alone, and accordingly, it is not necessary to interrupt the operation of a portable electronic equipment for charging its battery such as a secondary battery. Thus, these years, there has been great attention to the fuel cell as a power source for portable electronic equipment.

The fuel cell is composed of a fuel electrode which reacts with a fuel (for example, hydrogen gas and methanol) and an air electrode which reacts with oxidative gas (for example, air and oxide gas), interposing therebetween an electrolyte. There have been several kinds of fuel cells such as a phosphate fuel cell, a molten salt fuel cell, a solid oxide fuel cell, a solid polymer fuel cell and the like which are classified depending upon its application and property. Among these fuel cells, the polymer electrolyte fuel cell using a polymer electrolyte membrane has a high output power density. Thus, it can facilitate compactness, as well can operate at a low temperature (about 70 to 80 deg.C.), and further, deterioration in performance characteristics caused by a start and a stop of operation of the cell and the like is less, thereby it offers such an advantage that the service life of the cell can be long. Thus, there has been great attention to the fuel cell as a power source device for a portable electronic equipment. However, since the solid polymer fuel cell utilizes in general hydrogen gas as a fuel, which has a low volumetric energy density, it requires a fuel tank having a large capacity. Thus, the solid polymer fuel cell utilizing hydrogen gas as a fuel is not always suitable for a small sized portable electronic equipment. Thus, there has been considered and developed a fuel cell utilizing a liquid fuel such as methanol, ethanol, propanol, dimethylether, ethylene glycol or the like, which has a volumetric energy density higher than that of a gas such as hydrogen, as a power source device for a portable electronic equipment.

A direct methanol fuel cell (which will be hereinbelow abbreviated as “DMFC”) which is standard, will be hereinbelow explained as a typical one of the fuel cells using a liquid fuel. Referring to FIG. 1 which is a schematic view illustrating a configuration of a DMFC, the DMFC 100 comprises an electrolyte membrane/electrode assembly (which will be hereinbelow referred to as “MEA: Membrane Electrode Assembly”) composed of a solid polymer electrolyte membrane 102, and an anode catalyst layer 103 and a cathode catalyst layer 104 which are integrally joined to opposite surfaces of the solid polymer electrolyte membrane 102, and an anode diffusion layer 105 and a cathode diffusion layer 106 which respectively make contact with the anode catalyst layer 103 and the cathode catalyst layer 104, outside of the latter. Further, a fuel passage board 107 is arranged outside of the anode diffusion layer 105 which is formed therein with a fuel passage 110 having a fuel feed port 105 and a fuel discharge port 109. A methanol aqueous solution is fed into the fuel feed port 108 by way of a liquid feed pump. Similarly, an air passage board 111 is arranged outside of the cathode diffusion layer 106. The air passage board 111 is formed therein with an air passage 111 having an air feed port 112 and an air discharge port 114. Oxidant gas such as air is fed into the air feed port 112 by means of a blower or the like. The methanol aqueous solution fed into the fuel feed port 108 from a methanol aqueous solution tank by the liquid feed pump flows through a channel part (fuel passage 110) of the fuel passage board 107. The methanol aqueous solution flowing through the fuel passage 110 penetrates into the anode diffusion layer 105 making contact with the fuel passage board 107, and accordingly, the methanol aqueous solution is uniformly distributed over the diffusion layer 103. It is noted that although the bundle of the anode catalyst layer 103 and the anode diffusion layer 105 is the so-called anode electrode (negative electrode) or anode gas diffusion electrode, it will be hereinbelow abbreviated as “anode 120”. Similarly, although the bundle of the cathode catalyst layer 104 and the cathode diffusion layer 106 is the so-called cathode electrode (negative electrode) or cathode gas diffusion electrode, it will be hereinbelow abbreviated as “cathode 130”

Next, explanation will be made of the reaction of methanol aqueous solution fed to the anode catalyst layer 103. The methanol aqueous solution is resolved into carbonic acid gas (CO₂), protons (H⁺) and ions (e⁻) by a reaction exhibited by the following chemical formula (1):
CH₃OH+H₂O→CO₂+6H⁺+6e⁻ (1)

The thus produced protons are transmitted through the solid polymer electrolyte membrane 102 from the anode 120 side to the cathode 130 side, and are then cooperated with oxygen gas (O₂) in the air and electrons (e⁻) so as to produce water (H₂O) on the cathode catalyst layer 104 through a reaction exhibited by the following chemical formula (2):
6H⁺+3/2O₂+6e⁻→3H₂O (2)

The total chemical reaction formula based upon electrochemical reaction by the chemical formula (1) and the chemical formula (2) is exhibited by the following chemical formula:
CH₃OH+3/2O₂→CO₂+3H₂O (3)

The DMFC coverts directly the chemical energy into an electric energy through the reaction exhibited by chemical formula (3) so as to produce an electromotive force (power generation).

However, the methanol aqueous solution flowing in the fuel passage board 107 of the DMFC 100 cannot all penetrate into the anode diffusion layer 105. A part of the methanol aqueous solution is discharged, direct from the fuel discharge port 109 of the fuel passage board 107 with no reaction exhibited by chemical formula (1). Thus, there has been raised such a problem that the efficiency of availability (reaction) of the methanol aqueous solution fed into the DMFC 100 is low. In order to enhance this efficiency, improvement in the structure of the fuel passage board 107 has been attempted. However, it has not yet enhanced the efficiency of availability. Thus, in order to enhance the efficiency of availability, it has been also tried such an attempt that the methanol aqueous solution discharged from the fuel discharge port 109 is once returned into the methanol aqueous solution tank, and is then reused. However, the methanol and the water react with each other by 1:1 (mole ratio) as exhibited by the above-mentioned formula (1), and accordingly, the consumption of the methanol (molecular weight of 32) is about 1.8 times as large as that of the water (molecular weight of 18). Thus, should the methanol aqueous solution discharged from the fuel passage board 107 be returned to the methanol storage container as it is, the concentration of the methanol aqueous solution in the storage container would be gradually decreased. Thus, should the methanol aqueous solution whose concentration has become a lower concentration after being used, be returned through circulation as it is, insufficient methanol would be caused within the cell. Thus, the chemical reaction exhibited by the chemical formula (1) cannot be carried sufficiently. As a result, there would be caused such a disadvantage that the electromotive force (output voltage) abruptly decreases.

Accordingly, these years, there has been proposed a fuel cell power generation unit in which an initial concentration of the methanol aqueous solution in the methanol aqueous solution container is se to be high in order to enhance the efficiency of availability of fuel and to increase the output power of the DMFC, as disclosed in JP-A-2003-22830 (page 2). The fuel cell power source disclosed in this patent document evaluates a concentration of the methanol aqueous solution in the methanol aqueous solution container from a total electric value obtained by the fuel cell, and controls the flow rate of the methanol aqueous solution in accordance with the thus evaluated concentration of the methanol aqueous solution. Further, this patent document discloses a fuel cell power generation source (fuel cell power source) capable of long time operation which additionally includes a methanol refilling means composed of a second methanol aqueous solution container and a second liquid feed pump, for refilling the methanol aqueous solution into the above-mentioned methanol aqueous solution container in order to control the flow rate of the methanol aqueous solution fed to the cell.

However, in the fuel cell which utilizes a liquid fuel in circulation as disclosed in the above-mentioned patent document, since a concentration control mechanism which detects the concentration of the liquid fuel so as to maintain the concentration thereof at a predetermined value is provided, a plurality of pumps including a pump for feeding the liquid fuel having a high concentration and a pump for feeding water are required. Due to the provision of the plurality of pumps, the fuel cell power source can hardly be small-sized and light-weigh even by a method of saving a space occupied by accessories including the pumps within the fuel cell power source and reducing the consumption of electric power.

Further, methanol and water in the methanol aqueous solution fed to the anode catalyst layer 103 shown in FIG. 1 produces protons (H⁺), carbonic acid gas (CO₂) and ions (e⁻) as exhibited by the reaction formula (1). The thus produced carbonic gas passes through the anode diffusion layer 105 from the anode catalyst layer 103, then flowing through the fuel passage 110, and is then discharged from the fuel discharge port 109. The produced carbonic acid gas possibly causes the formation of large-sized air bubbles which have grown from fine bubbles in the methanol aqueous solution passing through the anode catalyst layer 103 or the anode diffusion layer 105 in the anode, and these large-sized air-bubbles of the carbonic acid gas often blocks the stream of liquid fuel in the anode diffusion layer 105. Thus, the quantity of the methanol aqueous solution fed to the anode diffusion layer 103 possibly becomes insufficient, causing the lowering of the power generation capacity (lowered output power). Accordingly, it has been desired to smoothly discharge the thus produced carbonic acid gas from the anode catalyst layer 103 or the anode diffusion layer 105 in the anode in order to prevent the methanol aqueous solution fed to the anode catalyst layer 103 from being blocked.

The above-mentioned JP-A-2000-22830 (page 2) discloses such a configuration that the concentration of the methanol aqueous solution is evaluated, and then, the flow rate of the methanol aqueous solution fed to the cell is controlled in accordance with the evaluated concentration thereof. Thus, the fuel cell power generation apparatus disclosed in the JP-A-2000-22830 (page 2) can enhance the efficiency of availability of fuel and the output power of the cell. However, the conventional fuel cell power generation apparatus as disclosed in this patent document has raised the following problems in such a case that it is used as a small-sized and light-weight power source for a portable electronic equipment:

(1) Due to the provision of a plurality of pumps for maintaining the concentration of the liquid fuel such as methanol at a predetermined value, an extra space for housing the pumps and an extra power for driving pumps and so forth are required, and accordingly, it is not suitable for a small-sized and light-weight power source;

(2) Unless carbonic acid gas produced in the anode through reaction exhibited by the above-mentioned chemical formula (1) is discharged smoothly, the liquid fuel such as methanol aqueous solution cannot be fed, sufficient to the anode, resulting in lowering of the output power of the cell;

(3) Since the liquid fuel such as methanol fed to the anode cannot sufficiently penetrate into the anode diffusion layer, the output power and the availability of fuel are lowered;

(4) Since the liquid fuel such as methanol fed to the anode cannot react smoothly in the anode, the output power and the availability of fuel are lowered; and

(5) Further, since the above-mentioned carbonic acid gas cannot be smoothly discharged from the anode, the output power cannot be stabilized, and accordingly, the fuel cell power generation apparatus cannot be operated for a long time.

### BRIEF SUMMARY OF THE INVENTION

An object of the present invention is to provide a fuel cell power source which can eliminate the necessity of provision of a plurality pump and which can therefore be small-sized and light-weight, and also to provide a method of operating thereof and as well, a portable electronic equipment using thereof.

Another object of the present invention is to provide a fuel cell power source which can smoothly discharge carbonic acid gas from an anode, which is produced through reaction in a fuel cell so as to enhance the output power of the fuel cell, and as well to provide a method of operating thereof and a portable electronic equipment using thereof.

Further, another object of the present invention is to provide a fuel cell power source in which a liquid fuel such as methanol fed into a fuel cell can penetrate, sufficient into an anode diffusion layer so as to enhance the output power and availability of the fuel cell, and also to provide a method of operating thereof and as well a portable electronic equipment using thereof.

Moreover, another object of the present invention is to provide a fuel cell power source in which the reaction of a liquid fuel such as methanol fed to an anode is promoted so as to enhance the output power and availability of a fuel cell, and to provide a method of operating thereof and as well a portable electronic equipment using thereof.

Further, another object of the present invention is to provide a fuel cell power source in which carbonic acid gas produced through reaction in a fuel cell can be smoothly discharged from an anode so as to operate the fuel cell for a long time with a stabilized output power, and also to provide a method of operating thereof and as well a portable electronic equipment using thereof.

According a principle concept of the present invention, there is provided a fuel cell incorporating a means for feeding a liquid fuel and water which are fed to an anode by a single pump through time-sharing.

According to a first concept of the present invention, there is provided a fuel cell power source comprising a fuel cell part composed of an anode, a cathode arranged so as to be opposed to the anode and a solid polymer electrolyte membrane interposed between the anode and the cathode, and a liquid fuel supply part for feeding a liquid fuel and water into the anode, the liquid fuel supply part incorporating a means for feeding the liquid fuel and the water to the anode by a single pump through time-sharing.

According to a second concept of the present invention, there is provide a method of operating a fuel cell power source comprising a fuel cell part composed of an anode, a cathode arranged so as to be opposed to the anode and a solid polymer electrolyte membrane interposed between the anode and the cathode, and a liquid fuel supply part for feeding a liquid fuel and water into the anode, including a step of feeding the liquid fuel and the water into the anode by a single pump through time-sharing.

With the configurations of the present inventions as stated above, the fuel cell power source can be small-sized and light-weight without the provision of a plurality of pumps, and the fuel cell power source can be operated for a long time with a stabilized output power by smoothly discharging a carbonic acid gas produced through a reaction in a fuel cell so as to drive the fuel cell power source, continuously for a long time. Further, the liquid fuel such as methanol fed to the cell can penetrate, sufficient to the anode diffusion layer, thereby it is possible to enhance the output power and the availability of the fuel.

Further, the reaction of the liquid fuel such as methanol fed to the anode is promoted so as to enhance the output power and availability of the fuel cell.

Other objects, features and advantages of the invention will become apparent from the following description of the embodiments of the invention taken in conjunction with the accompanying drawings.

### BRIEF DESCRIPTION OF THE SEVERAL VIEW OF THE DRAWING

FIG. 1 is a view for explaining a configuration of a direct methanol fuel cell;

FIG. 2 is a view for explaining a configuration of a fuel cell power source;

FIG. 3 is a view for explaining steams of liquid fuel and water in a fuel cell power source;

FIG. 4 is a flow-chart of a process routine I for adjusting a concentration of liquid fuel used in a fuel cell power source;

FIG. 5 is a flow-chart of a process routine II for adjusting a concentration of liquid fuel used in a fuel cell power source;

FIG. 6 is a schematic view for explaining a structure of a liquid feed pump used in a fuel cell power source;

FIG. 7 is a schematic view for explaining a structure of a liquid feed pump capable of operating through time-sharing, used in a fuel cell power source;

FIG. 8 is a view showing a liquid feed quantity of a liquid feed pump capable of operating through time-sharing, used in a fuel cell power source in a fifth embodiment of the present invention, and aging of concentration of a liquid fuel;

FIG. 9 is a view showing a liquid feed quantity of a liquid feed pump capable of operating through time-sharing, used in a fuel cell power source in an embodiment 6 of the present invention, and aging of concentration of a liquid fuel:

FIG. 10 is a view showing a voltage-current characteristic of a fuel cell power source in a reference example 1;

FIG. 11 is a view showing a voltage-current characteristic of a fuel cell power source in the reference example 1 during continuous power generation of the fuel cell power source in the reference example 1:

FIG. 12 is a view showing a voltage-current characteristic of a fuel cell power source in a comparison example 1;

FIG. 13 is a view showing a voltage-current characteristic of a fuel cell power source in the comparison example 1 during continuous power generation of the fuel cell power source in the comparison example 1;

FIG. 14 is a schematic view for explaining the configuration of a laptop computer according to the present invention;

FIG. 15 is a perspective view illustrating a PDA according to the present invention;

FIG. 16 is a schematic view for explaining the PDA according to the present invention; and

FIG. 17 is a view for explaining the configuration of the fuel cell power source used in the comparison example.

### DETAILED DESCRIPTION OF THE INVENTION

Detailed description will be hereinbelow made of embodiments of a fuel cell power source according to the present invention, and a portable electronic equipment using thereof.

Referring to FIG. 2 which shows a configuration of a fuel cell power source according to the present invention, the fuel cell power source 1 is mainly composed of a fuel cell part 10, a liquid fuel supply part 20, a control part 30, a power storage part 40 and an oxidant gas supply part 50.

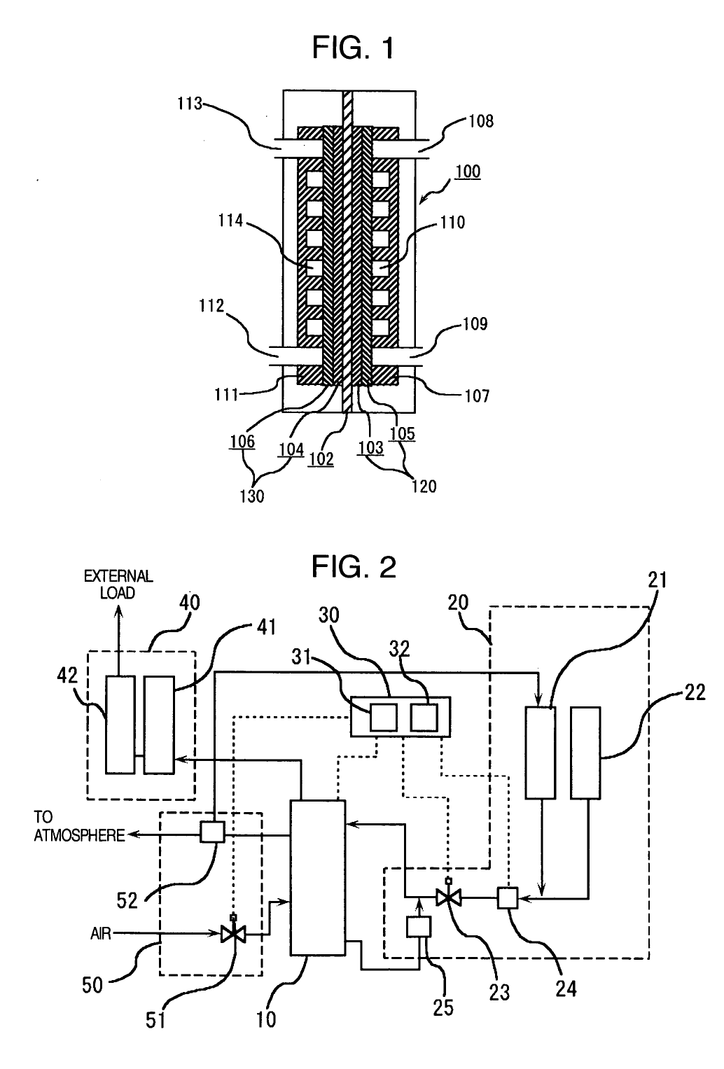

The fuel cell part 10 is formed of a liquid fuel cell the same as the direct methanol fuel cell (which will be hereinbelow referred to as “DMFC” which is abbreviation of the direct methanol fuel cell) 100 shown in FIG. 1.

Referring to FIG. 2, the fuel cell part 10 is adapted to generate an electric power through electrochemical reaction between a liquid fuel (which will be explained with the use of methanol which is a typical example) fed from the liquid fuel supply part 20 and an oxidant gas (which will be explained with the air which is a typical example) fed from the oxidant gas supply part 50.

The liquid fuel supply part 20 is composed of a container 21 for reserving water, a container 22 for reserving a high concentration of methanol aqueous solution and a water feed pump 23 for feeding the high concentration of methanol aqueous solution and water to the DMFC 100. The control part 30 is composed of a logic circuit under control of a mircocomputer, that is, CPU, a signal processing means 31 for processing a signal by means of the CPU, a storage means 31 using memory such as ROM and RAM, and I/O port (which is not shown) for receiving and delivering various signals.

The control part 30 controls the fuel cell power source 1 in its entirety, that is, it controls, by means of the microcomputer or the like, supply quantities of the high concentration methanol aqueous solution and water fed into the DMFC 100, the operation of a feed pump 23 therefor, that of the power storage part and that of a blower for feeding the air from the oxidant gas supply part 50 to the DMFC 100.

The power storage part 40 is composed of a DC-DC converter (chopper) 41, a battery part 42 (a chargeable lithium (Li) ion secondary battery, a super capacitor or the like). The power storage part 40 boosts up a d.c. power generated by the fuel cell part 10 by means of the DC-DC converter 41, and charges the thus boosted-up d.c. power in the battery part 42 such as a lithium (Li) ion battery, a super capacitor or the like from which the charged power is fed to an external load.

It is noted that the Li ion secondary battery, the super capacitor or the like in the battery part 42 discharges a power upon a start of the fuel cell power source 1, or when a power demanded by an external circuit is higher than that generated by the fuel cell part 10, in order to feed a required power therefor. Further, the lithium ion secondary battery or the super capacitor in the battery part 42 serves as a power source for the control part 30, the liquid feed pump 23, the air blower 51 and the like.

The oxidant gas supply pat 50 is adapted to feed oxidant gas such as the air into the fuel cell part 10 by means of the air blower 51.

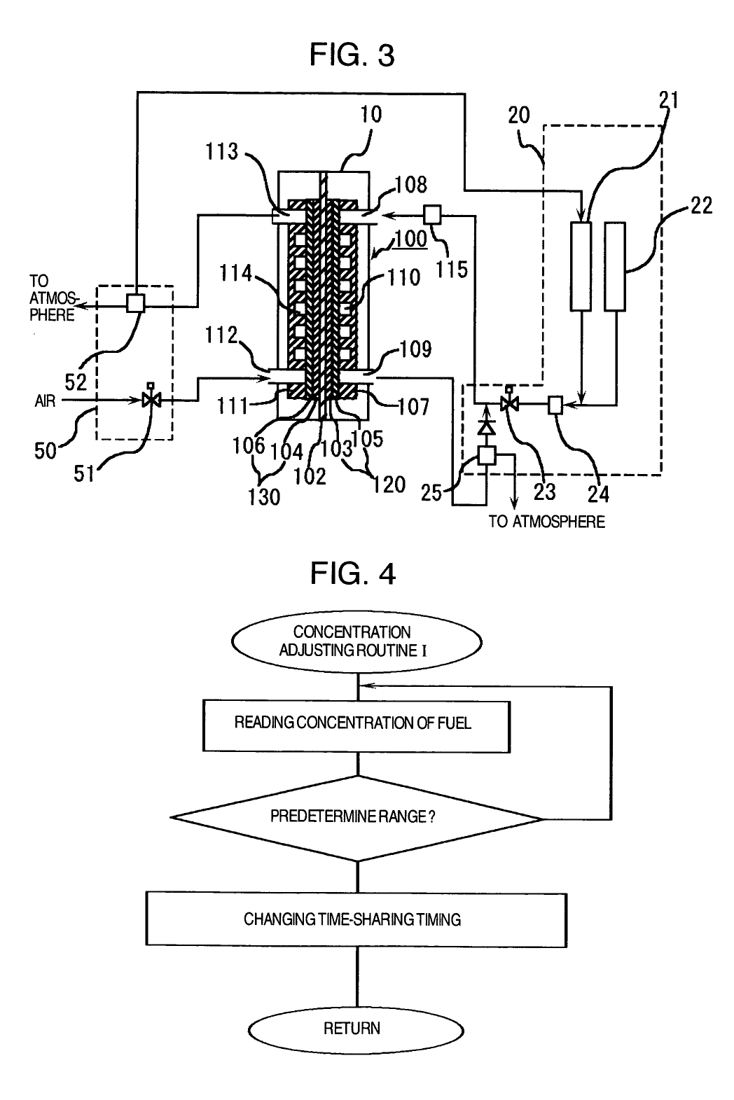

Next, referring to FIG. 3, detailed explanation will be hereinbelow made of a fuel cell power source 1 according to the present invention with reference to FIG. 1.

It is noted that like reference numeral are used in FIG. 3 to denote like parts to those shown in FIG. 1, and detailed explanation thereof will be omitted.

At first, explanation will be made of the stream of the methanol aqueous solution as a liquid fuel.

As to the methanol aqueous solution fed into the DMFC 100, water and methanol aqueous solution are alternately fed from a water container 21 and a methanol aqueous solution container 22 in the liquid fuel supply part 20 by means of the liquid feed pump 21. The alternate supply of the water and the methanol aqueous solution is carried out by changing over the connection between a passage for the water fed from the water container 21 in the liquid fuel supply part 20 and a passage fed from the methanol aqueous solution fed from the methanol aqueous solution container 22 therein by means of a solenoid valve 24. It is noted that the alternate supply of the water and the methanol aqueous solution can be executed only by a different type liquid feed pump 23 without using the solenoid valve 24. The water and the methanol aqueous solution which have been alternately fed are fed into the DMFC from the supply port 108 of the fuel passage board 107, flowing through the fuel passage 110, and are discharged from the fuel discharge port 019.

Further, the discharged methanol aqueous solution is mixed in a pipe line o the outlet side of the liquid feed pump 23 with water and methanol aqueous solution alternately fed from the liquid feed pump 23 after flowing through a gas/liquid separating part 25 where carbonic acid gas is removed, and are then fed again into the fuel supply port 108 of the fuel passage board 107. The methanol aqueous solution flowing through the fuel passage 110 penetrates into the anode diffusion layer 105 made of a porous material such as carbon paper since convex portions (corresponding to portions which are not the channels in the fuel passage 10) of the fuel passage board 107 are made into close contact with the anode diffusion layer 105, and is then fed into the anode catalyst layer 103 from the anode diffusion layer 105. The methanol aqueous solution fed in the anode catalyst layer 103 is decomposed into carbonic acid gas, protons and ions through the chemical reaction exhibited by the chemical formula (1).

The thus produced protons are shifted through the solid polymer electrolyte membrane 102 from the anode side to the cathode side thereof. The protons react with oxygen gas component in the air fed onto the cathode catalyst layer 104 and electrons on the cathode catalyst layer 104 so as to produce water through the reaction exhibited by the chemical formula (2). The produced water is returned into the water container 21 after flowing through a liquid/gas separator 52 from which air is removed from the water, and is thereafter used for adjusting the concentration of the methanol aqueous solution. The air fed into the cathode catalyst layer 104 is fed into the supply port 112 of the air passage board 111 and is then fed by the air blower 51 of the oxidant gas supply part 50 from the cathode diffusion layer 106 into the cathode catalyst layer 104 through the air channels formed in the air passage board 111. The thus fed air reacts in the cathode catalyst layer 104 so as to produce water.

Then, detailed explanation will be made of the DMFC 100.

The DMFC 100 is composed of an electrolyte membrane/electrode assembly (which will be hereinbelow referred to as “MEA” (Membrane Electrode Assembly) composed of the solid polymer electrolyte film 102, and the anode catalyst layer 103 and the cathode catalyst layers 104 which are integrally joined to opposite surfaces of the solid polymer electrolyte membrane 102, and the anode diffusion layer 106 and the cathode diffusion layer 106 which are respectively arranged outside of and are made into close contact with the anode catalyst layer 105 and the cathode catalyst layer 106, and the fuel passage board 107 and the air passage board 111 which are respectively arranged outside of and are made into close contact with the anode diffusion layer 105 and the cathode diffusion layer 106. The fuel passage board 107 is formed therein with the fuel passage 110 having the fuel supply port 108 and the fuel discharge port 113. The air passage board 111 is formed therein with the air passage 114 having the air supply port 114 and the air discharge port 115.

The solid polymer electrolyte membrane 102 used in the present invention should not be limited to a specific one, that is, any kind of solid polymer electrolyte membrane having a proton conductivity may be used therefor. Specifically, there may be used various kinds of solid polymer electrolyte membranes such as a fluorine group solid polymer electrolyte membrane which is represented by a polyperfluorosulfonic acid membrane which is know as the following trade names Nafion® (Trade Mark, produced by Dupon Co.,), Aciplex® (Trade Mark, produced by Asahi Kase Co., Ltd.) and Flemion® (Trade Mark, Asahi Glass Co., Ltd.), a sulfonic acid type polystyrene-graft-ethylenetetrafluoroehtylene copolymer (ETFE) membrane composed of a principal chain formed of a copolymer between fluorocarbon group vinyl monomer and hydrocarbon group vinyl monomer, and a hydrocarbon group side chain having a sulfonic group, as disclosed in JP-A-09-102322, a sulfonic acid type polystyrene-graft-ETFE membrane disclosed in JP-A-09-102322, a membrane formed from a copolymer of fluorocarbon group vinyl monomer and hydrocarbon group vinyl monomer, disclosed in U.S. Pat. No. 4,012,303 and U.S. Pat. No. 4,605,685, a partially fluorinated solid polymer electrolyte membrane such as a sulfonic acid type poly(trifluorostyrene)-graft-ETFE membrane which is a solid polymer electrolyte membrane obtained by introducing a sulfonic acid group into a graft copolymer of α, β, β-trifluorostyrene, a sulfonated polyether etherketone solid polymer electrolyte membrane disclosed in JP-A-06-93114, a sulfonated polyether ethersulfon solid polymer electrolyte membrane disclosed in JP-A-9-245818 and JP-A-11-116679, a sulfonated acrylonirile butadiene styrene polymer solid polymer electrolyte membrane disclosed in JP-A-10-503788, a sulfonated polysulfide solid polymer electrolyte membrane disclosed in JP-A-11-510198, a sulfonated polyphenylene solid polymer electrolyte membrane disclosed in JP-A-11-515040, and an aromatic hydrocarbon group solid polymer electrolyte membrane introduced thereinto with alkylene sulfonic acid group disclosed in JP-A-2002-110714, JP-A-2003-1000317 and JP-A-2003-187826.

Of the above-mentioned solid polymer electrolyte membranes, the aromatic hydrocarbon group solid polymer membrane is preferably used as the solid polymer electrolyte membrane 102 according to the present invention in view of its methanol permeability. In particular, an aromatic hydrocarbon group polymer membrane introduced therein with the alkylene sulfonic acid group is preferable in view of the methanol permeability, the swelling property and the durability thereof. Further, by using a composite electrolyte membrane composed of a heat-resistant resin micro-dispersed therein with a proton conductive inorganic substance such as a tungsten oxide hydrate, zirconium oxide hydrate, tin oxide hydrate, tungstosilicic acid, molybdosilicic acid, tungstophosphoric acid, molybdophosphoric acid or the like, there can be provided a fuel cell which can be operated in a high temperature range. It is noted that protons in these proton conductive acid electrolyte membranes are in general hydrated, and accordingly, the hydrated acid electrolyte membrane causes deformation between drying and wetting due to affection by swelling with water. Further, a membrane having a high ion conductivity possibly has an in sufficient mechanical strength. As to the countermeasure against the above-mentioned problems, it is effective that an unwoven fabric or a woven fabric containing fibers having a mechanical strength, a durability and a heat-resistance which are excellent, is used as a core material, or these fibers as a filler for reinforcement are added in an electrolytic membrane during manufacture of an electrolyte membrane, thereby it is possible to further enhance the reliable performance of the electrolyte membrane and the cell.

Further, it is possible to use a membrane in which polybenzimidazol group is doped with sulfonic acid phosphoric acid, sluforic acid group or phosphine acid group in order to reduce the fuel permeability (crossover) of the electrolyte membrane.

This solid polymer electrolyte membrane 102 preferably has a sulfonic acid equivalent (per dried resin) in a range from 0.5 to 2.0 mm equivalent/g, and more preferably in a range from 0.7 to 1.6 mm equivalent/g. If the sulfonic equivalent is smaller than the above-mentioned range, the ion-conductive resistance becomes larger (the ion conductivity decreases), but if the sulfonic acid equivalent is larger the range, the membrane becomes easily soluble with water so as to be unpreferable.

The thickness of the solid polymer electrolyte 120 is preferably in a range from 10 to 20 μm, and more preferably in a range from 30 to 100 μm although it may not be limited particularly in this range. In order to obtain a membrane having a practically durable strength, it is preferable to have a thickness larger than 10 μm, but in order to reduce the membrane resistance or to enhance the power generation performance, it is preferable to have a thickness less than 200 μm. The thickness of the electrolyte membrane can be controlled by a density of an electrolyte solution or a thickness of an electrolyte solution coated on a substrate in a case of a solution cast process. In the case of forming a membrane from a molten condition, the thickness of the electrolyte membrane can be controlled by a melt press process, a melt extrusion process or the like, that is, a film having a predetermined thickness is drawn by a predetermined scale factor. It is noted that an additive such as a plasticizer, a stabilizer or a mold release, which is normally used in a polymer during a manufacture of the solid polymer electrolyte membrane 102, may be used within a range which can attain its purpose without hindrance.

A catalyst layer of an electrode used in an MEA for a fuel cell is composed of a conductive material and fine particles of catalyst metal carried by the conductive material, and it may contain a water repellant or a binder as necessary. Further, a layer composed of a conductive material carrying no catalyst and a water repellant or a binder which is contained as necessary, may be arranged outside of this catalyst layer. As the catalyst metal used in the catalyst layer of the electrode, there may be used any metal which can promote the oxidation reaction of hydrogen and the reductive reaction of oxygen, such as platinum, gold, silver, palladium, iridium, rhodium, ruthenium, iron, cobalt, nickel, chromium, tungsten, manganese, vanadium or an ally thereof. Among these catalysts, a platinum is used as a cathode catalyst while a platinum-ruthenium alloy is used as anode catalyst in many cases. A particle size of the metal catalyst, is normally in a range from 10 to 300 Angstroms. It is advantageous that these catalysts are carried by a carrier such as carbon since the consumption of the catalyst is less so as be effective in costs. After formation of an electrode, the quantity of the anode catalyst is in a range from 0.5 to 20 mg/cm², and preferably in a range from 5 to 15 mg/cm², and the quantity of the cathode catalyst is in a range from 0.01 to 10 mg/cm² and preferably in a range from 0.1 to 10 mg/cm². The quantity of the anode catalyst is preferably greater than that of the cathode catalyst. The anode catalyst layer 102 is preferably thicker than the cathode catalyst layer 104 since the reaction exhibited by the chemical formula (1) through which protons and electrons are produced from methanol and water is slow. The thickness of the anode catalyst layer 102 is preferably in a range from 20 to 300 μm and particularly preferable in a range from 50 to 200 μm. The thickness of the cathode catalyst layer 104 is preferably in a range from 3 to 150 μm, and particularly preferable in a range from 5 to 50 μm. The anode catalyst layer 103 and the anode diffusion layer 105 are preferably subjected to a hydrophilic process in order to enhance the wettability with a liquid fuel such as methanol. On the contrary, the cathode layer 104 and the cathode diffusion layer 26 are preferably subjected to a water repelling process in order to prevent stagnation of produced water. In the method of subjecting the anode catalyst layer 103 and the anode diffusion layer 105 to the hydrophilic process, a carbon material used in the anode catalyst layer 103 and the anode diffusion layer 105 is treated by an oxidant selected from a group consisting of hydrogen peroxide, sodium hypochlorite, potassium permanganate, hydrochloride, nitrate, phosphoric acid, sulfuric acid, fuming sulfuric acid, hydrofluoric acid, acetate, ozone and the like, and then a hydrophilic group such as a hydroxyl group, a sulfonic group, a carboxy group, a phosphate group, a sulfuric ester group, a carbonyl group or an amino group is introduced in the carbon material. It is noted that an activating process by an electrolytic oxidation (anodic oxidation) or a steam oxidation or addition of a hydrophilic surface active agent or the like may be used for the method of introducing the hydrophilic group into the carbon material.

The hydrophilic process of the anode catalyst layer 103 for enhancing the wettability with methanol fuel, the increase of the thickness of the cathode catalyst layer 104 for prolonging the contact time so as to cause much more occurrence of the reaction in view of a rate-limitation of the reaction exhibited by the above-mentioned chemical formula (1), and the hydrophilic process of the anode catalyst layer and the water repelling process of the cathode diffusion layer 106 are preferable, since they allow carbonic acid gas produced from the anode through the reaction exhibited by the above-mentioned chemical formula (1) and water produced by the reaction in the cathode to be smoothly discharged outside from the cell, and increase the output voltage of the cell, and accordingly, it is effective for all liquid fuel cells, including a dilution circulation liquid fuel cell of a stack type and the so-called passive planar type liquid fuel cell in which a fuel and air are not fed by a pump and a blower but is fed through natural diffusion.

The conductive material carrying catalyst may be any one of electron conductive materials including various metals or carbon materials. Among them, as the carbon material, there may be exemplified furnace black, channel black, acetylene black, amorphous carbon, carbon nanotube, carbon nanohorn, active carbon or graphite which can be used solely or in mixture. The particle size of the carbon is, for example, not less than 0.01 μm but not greater than 0.1 μm and preferably not less 0.02 μm, but not greater than 0.06 μm. As the repellant used for the water repelling process, fluorinated carbon, polytetrafluoroethylene or the like is used. As the binder, it is preferable in view of adhesiveness to directly use a water/alcohol solution of a 5 wt. % of polyperfluorocarbon sulfonic acid electrolyte (The mixture of water, isopropanol and normarpropanol which are mixed by weight ratio of 20:40:40, manufactured by Fluca Chmica Co.,) used for covering electrode catalyst in the configuration of the present embodiment, but other various resins can be also conveniently used. In this case, it is preferable to add a fluorine resin having a water repelling ability, and in particular, a material excellent in heat-resistance and acid-resistance are more preferable. That is, there may be used, for example, polytetrafluoroethylene, tetrafluoroethylene-perfluoroalkyl vinylether copolymer, and tetrafluoroethylene-hexafluoropropyrene copolymer.

As a process of joining an electrolyte membrane and an electrode which are used for a fuel cell, any one of well-known process can be used, as disclosed in JP-A-05-182672 and JP-A-2003-187824, that is, it should not be limited to any particular process. A process of manufacturing an MEA, for example, comprising the steps of mixing Pt catalyst powder carried by carbon with a polytetrafluoroethylene suspension, then coating the thus obtained mixture over a carbon paper, carrying out heat treatment thereof so as to form a catalyst layer, next coating an electrolyte solution the same as the electrolyte membrane over the catalyst layer, and hot-pressing the catalyst layer and the electrolyte membrane so as to integrally incorporate them with each other. In addition, there may be used a process of coating beforehand Pt catalyst powder thereover with an electrolyte solution the same as the electrolyte membrane, a process of coating an electrolyte membrane with a catalyst paste, a process of electroless-depositing an electrode on an electrolyte membrane, a process of adsorbing platinum group metal complex ions to an electrolyte membrane, and thereafter reducing thereof.

The solid polymer fuel cell is composed of a plurality of unit cells which are stacked one upon another through the intermediary of cooling panels or the like therebeween, each unit cell being composed of a conjugation element consisting of the electrolyte membrane formed as stated above, and the gas diffusion electrode, and a fuel distribution board and an oxidant distribution board arranged on opposite sides of the conjugation element and formed therein with fuel passages and oxidant passages so as to serve as power collectors with channels. In stead of connecting the unit cells in a stack, they may be connected in a plane. It is noted that the unit cells may be connected either in a stack or in a plane, that is, the connection should not be limited to one of them. It is desirable to operate the fuel cell at a high temperature since the catalyst in the electrode is activated so as to reduce the electrode overvoltage, but no limitation is present to the operating temperature thereof. The liquid fuel can be evaporated so as to operate the fuel cell at a high temperature.

Next, explanation will be made of the adjustment to the concentration of the methanol aqueous solution fed into the DMFC 100, and the method of feeding thereof. At first, the concentration of the methanol aqueous solution fed to the DMFC 100 will be explained. In the case of using a fluorine group solid polymer electrolyte membrane, the methanol aqueous solution fed to the DMFC 100 is controlled in a range from 3 to 15 wt. % and preferably in a range from 5 to 10 wt. %. In this case, the concentration of the aqueous solution higher than 15 wt. %, causes such a tendency that the quantity of methanol permeating through the electrolyte membrane is increases, resulting in lowering of the availability of the methanol, and accordingly, it is not preferable. Further, in the case of using an aromatic hydrocarbon group solid polymer electrolyte membrane, a quantity of methanol permeating through the electrolyte membrane is less, and accordingly the concentration of the methanol aqueous solution in the DMFC 100 is set appropriately in a range 5 to 64 wt. % and preferably in a range 20 to 60 wt. %. Since the methanol in the methanol aqueous solution is consumed in the anode catalyst layer 103 through the reaction exhibited by the above-mentioned chemical formula (1), the methanol concentration in the methanol aqueous solution is gradually decreased. Thus, should the methanol aqueous solution be returned, direct to the DMFC 1 after carbonic acid gas discharged from the fuel passage board 110 is removed therefrom in the gas-liquid separator 25, the methanol would become deficient in the cell so as to cause a problem of abrupt drop of an electromotive force.

Thus, the concentration of the methanol aqueous solution is detected by the methanol concentration sensor 240 provided in the DMFC 100, and the data is transmitted to the control part 30.

The control part 30 then delivers a signal from a signal processing means 31 so as to control the concentration of the methanol aqueous solution to a value preset in a memory means 32. Specifically, the control part 30 delivers a signal from the signal processing means 31 so as to switch over the solenoid valve 24 provided on the inlet side of the liquid feed pump 23 through time-sharing for changing over between a passage connecting the outlet of the methanol aqueous solution container 22 to an inlet of the liquid feed pump 23 and a passage connecting the outlet of the water container 21 to the inlet of the liquid feed pump 23 when the methanol aqueous solution and water are fed through the liquid feed pump 23. Further, the liquid feed pump 23 feeds the water and the methanol aqueous solution through time-sharing by the solenoid valve 24. It is noted that the water and the methanol aqueous solution can be alternately fed only by the liquid feed pump 23 without using the liquid feed pump 23.

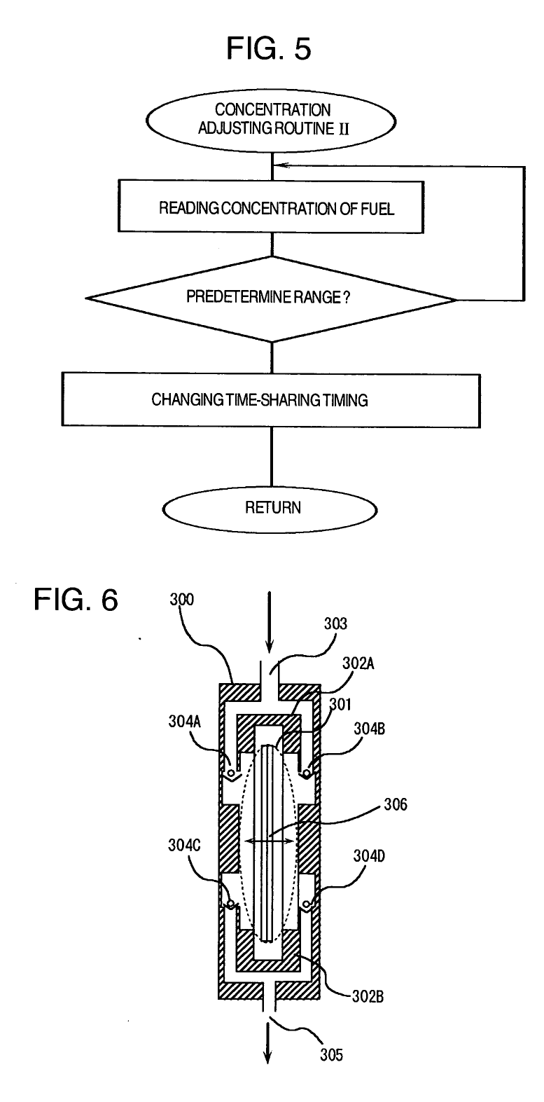

FIGS. 4 and 5 show methods of adjusting a concentration of a methanol aqueous solution fed to the DMFC, executed by the control part 30, among which FIG. 4 shows a process routine I for adjusting a concentration of a methanol aqueous solution with the use of the solenoid valve 24 and FIG. 5 is a process routine II for adjusting a concentration of a methanol aqueous solution with no use of the solenoid valve 24. Referring to FIG. 4, when the process routine I is started, the control part 30 carries out the following execution steps of reading a methanol concentration detected by the methanol concentration sensor 240 provided in the DMFC 100 (step S1), then determining whether the concentration of the methanol aqueous solution in the DNFC falls in an appropriate range or not on the basis of a detection signal from the methanol concentration sensor 240 (step S2), changing the timing (which has been previously stored in the memory) of change-over by the solenoid valve 34 between the passage for the methanol aqueous solution and the passage for the water if it is determined at step S2 that the concentration of the methanol aqueous solution in the DMFC 100 is not in the appropriate range (step S3), and then ending this process routine I. If it is determined at step S2 that the concentration of the methanol aqueous solution in the DMFC 100 is in the appropriate range, at step S1, the methanol concentration is read again.

Referring to FIG. 5, when the process routine II is started, the control part 30 carries out the following process steps of reading a methanol concentration detected by the methanol sensor 204 provided in the DMFC 100 (step S11); then determining being based upon a detection signal detected by the methanol temperature sensor 240 provided in the DMFC 100 whether the concentration of the methanol aqueous solution in the DMFC 100 falls in an appropriate range or not (step S12); changing the timing (which has been previously stored in the memory) of time allocation of the liquid feed pump 23 for feeding the methanol aqueous solution and the water if it is determined at step S12 that the concentration of the methanol aqueous solution in the DMFC 100 is not in the appropriate range (step S13); and ending the process routine II. If it is determined at step S12 that the concentration of the methanol aqueous solution in the DMFC 100 is in the appropriate range, at step S1, a methanol concentration is again read.

With the concentration control carried out as stated above, when the methanol aqueous solution and the water are fed by the liquid feed pump 23, the operation of the solenoid valve 24 provided in the inlet side of the liquid feed pump 23 is time-shared in accordance with a timing which has been previously stored in the memory so as to change over between the passage connecting the outlet of the methanol aqueous solution container 22 to the inlet of the liquid feed pump 23 and the passage connecting the outlet of the water container 21 to the inlet of the liquid feed pump 23 in order to set the concentration of the methanol aqueous solution in the appropriate range. The timing with which the solenoid valve 24 is changed over between the passage for the methanol aqueous solution and the passage for the water should not be limited to a particular value. However, if it is desired to smoothly discharge carbonic acid gas from the fuel passage 110 in the DMFC 100 with the use of pulsation, the timing with which the solenoid valve 100 changes over between the passage for the methanol aqueous solution and the passage for the water is suitably set in a range from 100 to 0.001 cycle per second and preferably in a range from 60 to 0.2 cycle per second. Although the concentration of the methanol aqueous solution in the methanol aqueous solution container 22 has not to be particularly limited to a specific one, it is preferable that the concentration of the methanol aqueous solution in the methanol aqueous solution container 22 is higher since the higher the concentration of the methanol aqueous solution, the larger the content of methanol, the continuous operation time becomes longer if the volume is not different. It is in general to set the concentration of the methanol aqueous solution in a range from 30 to 100 wt. % and in particular, preferably to a value not less than 90 w. %. It is noted that the feed rates thereof are determined by volumes defined by left and right partition walls in the case of using a time-sharing type pump as the liquid feed pump 23, and accordingly, the concentration of the methanol aqueous solution in the methanol aqueous solution container 22 is determined by a ratio between volumes defined by the left and right partition walls.

Next, explanation will be made of a method of feeing a liquid fuel (methanol aqueous solution) and water by means of a single liquid feed pump 23. This method has not to be limited to a particular one but may be any of various methods in which the methanol aqueous solution and the water are fed alternately by a single liquid feed pump 23 through time-sharing. The specific methods are as follows:

(1) a method of feeding the methanol aqueous solution and the water with the timing of change-over by the solenoid valve 24 provided in the inlet side of the liquid feed pump 23 between the passage connecting the outlet of the methanol aqueous solution container 22 to the inlet of the liquid feed pump 23 and the passage connecting the outlet of the water container 21 to the inlet of the liquid feed pump 23 when the methanol aqueous solution and the water are fed by the liquid feed pump; and

(2) a method of feeding the methanol aqueous solution and the water fed to inlets of the pump having not less than two volumes, such as a piezoelectric pump or a plunger pump having not less than two volumes in the inlets thereof, through time-sharing with separate timings.

The liquid feed pump used in the method (1), has not to be limited to a particular one but may be any of various pumps which can feed a liquid fuel. As such a pump, there may be used (A) a turbo type pump, (A-1) an centrifugal pump such as a volute pump or a diffuser pump, (A-2) a mixed flow pump such as a volute type mixed flow pump or a mixed flow pump, (A-3) an axial flow pump, (B) a positive displacement pump, (B-1) a reciprocating pump such a piston pump, a piezoelectric pump, a plunger pump or a diaphragm pump, (B-2) a rotary pump such as a gear pump, a screw pump or a vane pump, and (C) a special pump such as a vortex pump (cascade pump), an air bubble pump (air lift pump) or a jet pump.

Further, the method (2) utilizes a piezoelectric pump or a plunger pump. The piezoelectric pump or the plunger pump is usually devised such that a liquid is sucked into one of blocks while the liquid is discharged from the other one of blocks so as to always feed the one and the same quantity of the liquid through every stroke, and accordingly, it can uniformly transfer one and the same quantity of the liquid always. In this method (2), a passage for feeding a liquid fuel such as a methanol aqueous solution is connected to an inlet of one of the blocks of, for example, a plunger pump or a piezoelectric pump, and a passage for feeding water is connected to an inlet of the other one of blocks so as to discharge the water while the methanol aqueous solution is sucked but to discharge the methanol aqueous solution while the water is sucked. That is, this method feeds the methanol aqueous solution and the water to the DMFC 100 through the time-sharing of the timings.

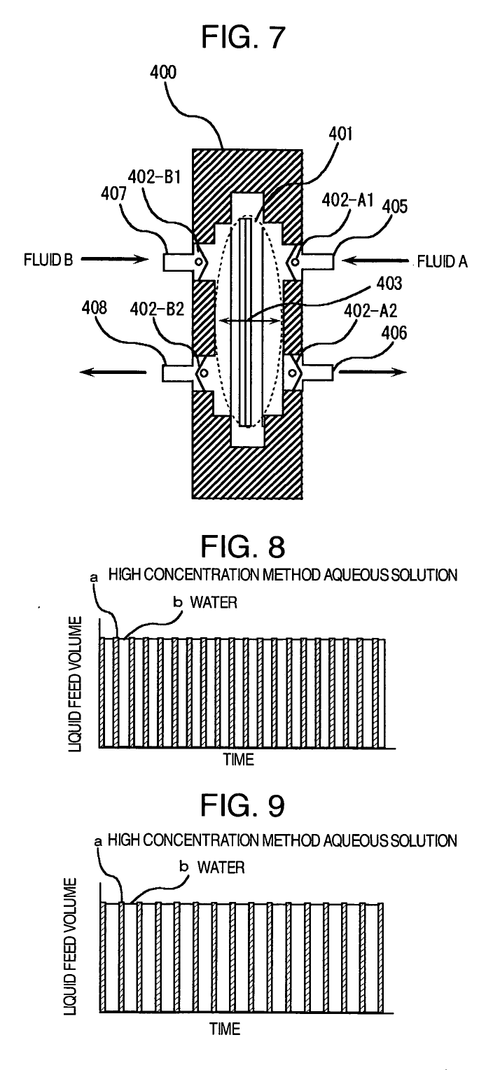

Referring to FIGS. 6 and 7 which schematically show a structure of the piezoelectric liquid feed pump, among which FIG. 6 shows a piezoelectric liquid feed pump used in the method (1) and FIG. 7 is a piezoelectric liquid feed pump used in a method (2), these piezoelectric liquid feed pump are more preferable for the DMFC which requires feeding a small quantity of liquid at a high head pressure with a less power consumption. At first, explanation will be made of the operation of a conventional piezoelectric pump shown in FIG. 6. Check valves 304 open only in one direction. Referring to FIG. 6, when a bimorph vibrator 301 made of polyvinylidene fluoride is displaced to the right position in FIG. 6, the check valve 304A on the inlet side for the left side fluid is opened while the check valve 304C on the outlet side for the left side fluid is closed. At this time, fluid is sucked into a left side partition wall chamber from a fluid inlet port 303. Further, at this time, a check valve 304B on the inlet side for the right side fluid is closed while a check valve 304D on the outlet side of the fluid is opened, and accordingly, fluid which has dwelled in a right side partition wall chamber is delivered outside of the pump. On the contrary, the bimorph vibrator 301 is displaced to the left side, the fluid which has dwelled in the right side partition wall chamber is delivered from the partition wall chamber while fluid is led into the left side partition wall chamber. The bimorph vibrator 301 is displaced left and right with an amplitude 306 in accordance with a frequency. Thus, with the repetitions of the displacement, the feed quantity of liquid in one direction varies, depending upon a frequency, the higher the frequency, the larger the feed quantity of liquid.

Next, explanation will be made of the operation of a piezoelectric liquid feed pump shown in FIG. 7 in this embodiment. Referring to FIG. 7, when a bimorph vibrator 401 made of polyvinylidene fluoride is displaced to the right side position in FIG. 7, a check valve 402-B1 in an inlet port 407 for a left side fluid B is opened while a check valve 402-B2 in an outlet port 408 for the left side fluid B is closed, and accordingly, the fluid B is fed into a left side partition wall chamber. Meanwhile, a check valve 402-A1 in an inlet port 405 for a right side fluid A is closed while the a check valve 402A-A2 in an outlet port 406 for the left side fluid A is opened, and accordingly, the fluid A which has dwelled in the right side partition wall chamber is fed out. On the contrary, when the bimorph vibrator 401 is displaced to the left side, the fluid B which has dwelled on the left side is fed out from the partition wall chamber while the fluid A is fed into the right side partition wall chamber. The bimorph vibrator 401 is displaced left and right with an amplitude 403, depending upon a frequency, and accordingly, with the repetitions of the displacement, the fluid A and the fluid B are alternately fed. The feed quantity of liquid varies depending upon a frequency, the higher the frequency, the larger the feed quantity of liquid. FIG. 8 shows variations in the feed quantity and the concentration of the liquid which is fed by the time-sharing type piezoelectric liquid feed pump, with time. In this figure, “a” exhibits the supply of the methanol aqueous solution and “b” exhibits the supply of water. From FIG. 8, it can be understood that the liquid fed into the DMFC 100 by the time-sharing type liquid feed pump has pulsation and temperature variation. Further, if the volumes of the left and right partition wall chambers of the piezoelectric liquid feed pump are different from each other, the ratio of quantities of liquid to be fed can be changed. Specifically, FIG. 9 shows variations in the feed quantity and the concentration of liquid, with time, when the volume of the partition wall chamber through which the water flows is set to a value which is two times as large as the volume of the partition wall chamber through which the methanol aqueous solution flows. In comparison between FIG. 8 and FIG. 9, the feed quantity of the water (b in the figure) in FIG. 9 is about two times as large as that in FIG. 8. Thus, it is effective to change the ratio between volumes of the partition wall chambers in the time-sharing type liquid feed pump.

Next, explanation will be made of the essential features of the present invention in view of reference examples 1 to 14 and comparison examples 1 and 2. It is noted that the present invention should not be limited to these reference numerals.

### REFERENCE EXAMPLE 1

The configuration of a fuel cell power source in an embodiment 1 of the present invention was the same as that of the fuel cell power source 1 shown in FIG. 1. Detailed explanation will be hereinbelow made in particular of a solid polymer electrolyte membrane 102, an anode catalyst layer 103, a cathode catalyst layer 104, an anode diffusion layer 105, a cathode diffusion layer 103, a fuel passage board 407 and an air passage board 111 which constitute a DMFC 100 used in the embodiment 1, in succession.

As the solid polymer electrolyte membrane 102, a polyperflurocarbon sulfonic acid membrane (Trade Mark: Nafion 117 manufactured by Dupon Co.) was used. The anode catalyst layer 103 was formed by applying a slurry obtained by preparing catalyst powder in which 50 wt. % of platinum/ruthenium particles having an atom ratio of 1/1 between platinum and ruthenium was dispersed to and carried by carbon carriers, and 5 wt. % polyperfluorocabon sulfonic acid electrolyte as a binder into a water/alcohol mixture solution (a mixture in which water, isopropanol and normal propanol which were mixed by a weight ratio of 20:40:40 in a solvent was used, manufactured by Fluca Chemica Co.), on a polytetrafluoroethylene film with the use of a screen printing process so as to form a porous catalyst layer having a thickness of about 20 μm. The cathode catalyst layer 104 was formed by applying a slurry obtained by preparing catalyst powder in which 30 wt. % of platinum particles was carried by carbon carriers, and 5 wt. % of Nafion 117 into a water/alcohol mixture solution (a mixture in which water, isopropanol and normal propanol which were mixed by a weight ratio of 20:40:40 in a solvent was used, manufactured by Fluca Chemica Co.), on a polytetrafluoroethylene film with the use of a screen printing process so as to form a porous catalyst layer having a thickness of about 25 μm. The anode catalyst layer 103 and the cathode catalyst layer 104 were cut into pieces each having a width of 10 mm and a length of 20 mm. Thus, the anode catalyst layer 103 and the cathode catalyst layer 104 were obtained.

Next, explanation will be made of the method of forming the membrane electrode assembly (MEA). The MEA electrode is obtained by at first joining the anode catalyst layer 103 to one side surface of the solid polymer electrode membrane 100. This anode catalyst layer 103 is superposed on a power generation part (electrode) of the solid polymer electrolyte membrane 102 after the anode catalyst layer 103 is impregnated over its surface with a water/alcohol mixture solution (a mixture in which water, isopropanol and normal propanol which were mixed by a weight ratio of 20:40:40 in a solvent was used, manufactured by Fluca Chemica Co.) of 5 wt. % of Nafion 117 by about 0.5 ml. Then it is dried at a temperature of 80 deg.C. for 3 hours under a load of about 1 kg. Thus, the anode catalyst layer 103 is joined to the solid polymer electrolyte membrane 102.

Next, the MEA electrode is formed by joining a cathode catalyst layer 104 to the solid polymer electrolyte membrane 102 on the surface side remote from the side on which the anode catalyst layer 103 is joined. This cathode catalyst layer 107 is superposed on a power generation part (electrode) of the solid polymer electrolyte membrane 102 after the cathode catalyst layer 104 is impregnated over its surface with a water/alcohol mixture solution (a mixture in which water, isopropanol and normal propanol which were mixed by a weight ratio of 20:40:40 in a solvent was used, manufactured by Fluca Chemica Co.) of 5 wt. % of Nafion 117 by about 0.5 ml. Then it is dried at a temperature of 80 deg.C. for 3 hours under a load of about 1 kg. Thus, the anode catalyst layer 103 is joined to the solid polymer electrolyte membrane 102.

Next, explanation will be made of a method of preparing the anode diffusion layer 105 and the cathode diffusion layer 106. The anode diffusion layer 105 was formed as follows: Carbon powder after calcination was added in an aqueous dispersion of repellent polytetrafluoroethylene fine particles (Teflon dispersion D-1 manufactured by Daikin Industrial Co.) so as to obtain 40 wt. % concentration after calcination, and was kneaded so as to obtain a paste. Then, the paste was built up on one surface of a carbon cloth carrier having a thickness of 350 μm and a void rate of 87% up to a thickness of 20 μm, and after drying at a room temperature, was calcined at a temperature of 270 deg. for 3 hours so as to obtain a carbon sheet. The carbon sheet was cut into pieces having a size equal to that of the MEA electrode as stated above. Thus, the anode diffusion layer 105 was obtained. The cathode diffusion layer 106 was formed as follows: Carbon powder after calcination was added in an aqueous dispersion of repellent polytetrafluoroethylene fine particles (Teflon dispersion D-1 manufactured by Daikin Industrial Co.) so as to obtain 40 wt. % concentration after calcination, and was kneaded so as to obtain a paste. Then, the paste was built up on one surface of a carbon cloth subjected to a water repellent process and having a thickness of 350 μm and a void rate of 87% up to a thickness of 20 μm, and after drying at a room temperature, was calcined at a temperature of 270 deg. for 3 hours so as to obtain a carbon sheet. The carbon sheet was cut into pieces having a size equal to that of the MEA electrode as stated above. Thus, the cathode diffusion layer 105 was obtained.

The MEA electrode in which the anode catalyst layer 103 and the cathode catalyst layer 104 are integrally joined to both surfaces of the solid polymer electrolyte membrane 102, is made at both surfaces thereof into close contact with the anode diffusion layer 105 and the cathode diffusion layer 106. The air passage board 111 is arranged outside of the cathode diffusion layer 105, and formed therein with the air passage 114 having the air supply port 106 and the air discharge port 113. The air is fed by the air blower in the oxidant gas supply part 50. Meanwhile, the fuel passage board is arranged outside of the anode diffusion layer 105, and formed therein with the fuel passage 110 having the fuel supply port 108 and the fuel discharge port 109. The methanol aqueous solution fed to the fuel passage board 107 is controlled so as to have a concentration in an appropriate range by the control part 30. This control is made in such a way that the timing of the time-sharing of the solenoid valve 24 which is provided on the inlet side of the liquid feed pump 23 and which changes over between the passage connecting the outlet port of the methanol aqueous solution container 22 to the inlet port of the liquid feed pump 23 (the pump shown in FIG. 6) and the passage connecting the outlet port of the water container 21 to the inlet port of the liquid feed pump 23. It is noted that the timing was controlled so as to easily cause pulsation so as to change over the solenoid valve 24 in a range of 50 to 0.2 cycles in order to smoothly discharge carbonic acid gas produced in the anode through the reaction exhibited by the chemical formula (1), from the cell.

It is noted that explanation of fuel cell power sources used in the following reference examples 2 to 14 and comparison examples 1 and 2 will be explained as to distinct parts which are different from those explained in the reference example 1, that is, the explanation of the parts common to the reference example 1 will be omitted.

### REFERENCE EXAMPLE 2

20 g of carbon powder used in the reference example 1 was mixed with 200 ml of fuming sulfuric acid (having a concentration of 60%) in a 300 ml flask, and was held under a stream of nitrogen with a temperature of 60 deg.C. being maintained for 2 days so as to be reacted. The color of the reacted liquid was changed from black into brown. Then, cooling was continued until the temperature of the flask was lowered to a room temperature, and then, the reacted liquid was gradually added under agitation in the flask in which 600 ml of distilled water was present while it was cooled by ice, and after reacted liquid was added in its entirety, it was filtered. The thus obtained filtered deposition was washed sufficiently by distilled water until the detergent becomes neutral. Thereafter, the deposition was washed with methanol and diethyelether in the mentioned order, and was dried under vacuum at a temperature of 40 deg.C. so as to obtain a derivative of carbon powder.

This carbon powder was measured by an infrared spectrometer, and as a result, optical absorption were found at 1,255 cm⁻¹ and 1,413 cm⁻¹, being based upon —OSO₃H group. Further, optical absorption was also found at 1,049 cm⁻¹, being based upon —OH group. This results show that —OSO₃H group and —OH group were introduced on the surface of the carbon powder treated with the fuming sulfuric acid. The contact angle between the carbon powder treated with the fuming sulfuric acid and the methanol aqueous solution is smaller than that between a carbon powder not treated with fuming sulfuric acid and the methanol aqueous solution, that is, it is hydrophilic. Further, the carbon powder treated with fuming sulfuric acid exhibited an excellent conductivity in comparison with the carbon powder not treated with fuming sulfuric acid. This carbon powder treated with fuming sulfuric acid was added in a water/alcohol mixture solution of 5 wt. of Nafion 117 (a solvent obtained by mixing water, isopropanol and normalpropanol with a weight ratio of 20:40:40, manfuactued by Fluca Chemica Co.) so as to obtain a paste which was then build up on one surface of a carbon cloth having a thickness of about 350 μm and a void rate of 87% and used for the carrier of the anode diffusion layer, up to a thickness of about 20 μm, and which was then dried at a temperature of 100 deg.C. so as to obtain a carbon sheet. The thus obtained sheet was cut into pieces having a size the same at that of the above-mentioned MEA electrode. Thus, the anode diffusion layer 106 was obtained. The fuel cell power source having a configuration the same as that in the reference example 1, except that mentioned above, was used so as to carry out tests.

### REFERENCE EXAMPLE 3

The carbon cloth having a thickness of about 350 μm and a void rate of 87% was soaked in a flask containing therein fuming sulfuric acid (having a concentration of 60%) so as to be treated, similar to the carbon powder treated with fuming sulfuric acid in the embodiment 2. As a result, the carbon cloth treated with fuming sulfuric acid was introduced onto its outer surface with —OSO₃H group and —OH group, and accordingly, it was excellent in hydrophilicity and conductivity. The fuel cell power source having a configuration the same as that in the reference example 2, except that the carbon cloth treated with fuming sulfuric acid was used as the carrier of the anode diffusion layer 105, was used and tests were carried out.

### REFERENCE EXAMPLE 4

In stead of polyperfluoro carbon sulfonic acid membrane in the solid polymer electrolyte membrane in the embodiment 1, sulfomethyl polyether sulfonic acid hydrogen group electrolyte was used. Further, 30 wt. % of sulfomethyl polyether sulfonic acid electrolyte was used as the binder in the anode diffusion layer 103. Except the above-mentioned configuration, the fuel cell power source having a configuration the same as that in the reference example 2 was used and test were carried out. In this case, the anode catalyst layer 103 were formed as follows: First, a catalyst powder in which fine particles of a platinum/ruthenium alloy having an atom ratio of 1/1 between platinum and ruthenium was dispersed in and carried on a carbon powder used for the carrier of the anode catalyst layer 103 was prepared. Then, a slurry composed of this catalyst powder, a water/alcohol solution of 30 wt. % of sulfomethylpolyether sulfonic acid hydrocarbon group electrolyte (a solvent obtained by mixing water, isopropanol and normalpropanol with a weight ratio of 20:40:40. manufactured by Fulca Chemica Co.), a dispersing agent and a repellent was prepared, and was build up on a polytetrafluoroethylene film by a screen printing process so as to obtain to a porous catalyst layer having a thickness of about 25 μm, and this porous catalyst layer was used as the anode catalyst layer 103.

### REFERENCE EXAMPLE 5

A fuel cell power source having a configuration the same as that in the reference example 4, except that the concentration of the methanol aqueous solution fed to the DMFC used in the reference example 4 was carried out only by the time-sharing type piezoelectric liquid feed pump as shown in FIG. 7 with no use of the solenoid valve 24, was used so as to carry out tests.

### REFERENCE EXAMPLE 6

A fuel cell power source having a configuration the same as that in the reference example 5, except volumes of left and right partition wall chambers of the time-sharing type piezoelectric liquid feed pump are different from each other so that the volume of the partition wall chamber through which the water flows is two times as larger as that of the partition wall chamber through which the methanol aqueous solution flows, was used so as to carry out tests.

### REFERENCE EXAMPLE 6

A fuel cell power source having a configuration the same as that in the reference example 5, except the thickness of the anode catalyst layer 103 was changed from 25 μm to 40 μm and the thickness of the cathode catalyst layer 104 was changed from 20 μm to 15 μm, was used so as to carry out tests.

### REFERENCE EXAMPLE 8

A fuel cell power source having a configuration the same as that in the reference example 7, except that carbon powder used in the reference example 1 was treated with fuming sulfuric acid the same as that in the reference example 2, and the thus obtained hydrophilic carbon powder was used in the anode diffusion layer 105, was used so as to carry out tests.

### REFERENCE EXAMPLE 9

A fuel cell power source having a configuration the same as that in the reference example 8, except that the carbon cloth used in the reference example 3 was treated with fuming sulfuric acid which is the same as that in the reference example 3, and the thus obtained hydrophilic carbon cloth was used in the anode diffusion layer 105, was used so as to carry out tests.

### REFERENCE EXAMPLE 10

A fuel cell power source having a configuration the same as that in the reference example 8, except that instead of the carbon cloth used for carriers of the anode diffusion layer 105 and the cathode diffusion layer 106, a carbon paper was used for the carriers, was used so as to carry out tests.

### REFERENCE EXAMPLE 11

The cathode catalyst layer 104 used in the reference example 11 was formed as follow: At first, a catalyst powder in which 50 wt. % of a catalyst of fine particles of a platinum/ruthenium alloy having an atom ratio of 1/1 between platinum and ruthenium was dispersed in and carried on a carbon powder used for the carrier of the cathode diffusion layer 104 was prepared. Next, a slurry composed of this catalyst powder, a water/alcohol mixture solution of 30 wt. % of sulhomethylpolyether sulfonic hydrocarbon group electrolyte (a solvent obtained by mixing water, isopropanol and normalpropanol with a weight ratio of 20:40:40: Fulca manufactured by Chemica C.), a dispersing agent and a repellant was prepared, and was then build up on a polytetrafluoroethylene film by a screen printing process so as to form a porous catalyst layer having a thickness of about 15 μm. The fuel cell power source having a configuration the same as that in the reference example 10, except that the porous catalyst layer was used as the cathode catalyst layer 104, was used so as to carry out tests.

### REFERENCE EXAMPLE 12

A fuel cell power source having a configuration the same as that in the embodiment 11, except that a hydrophilic carbon powder which was obtained by treating the carbon powder used in the reference example 1 with fuming sulfuric acid the same as that used in the reference example 2, was used for the carrier of the anode catalyst layer, was used so as to carry out tests.

### REFERENCE EXAMPLE 13

A fuel cell power cell having a configuration the same as that in the reference example 12, except that the thickness of the anode catalyst layer 103 was changed from 40 to 60 μm, was used so as to carry out tests.

### REFERENCE EXAMPLE 14

A fuel cell power source having a configuration the same as that in the reference example 13, except that the thickness of the anode catalyst layer 103 was changed from 60 to 80 μm, was used so as to carry out tests.

### COMPARISON EXAMPLE 1

Referring to FIG. 17 which shows a configuration of a fuel cell power source used in a comparison example 1, the configuration of the fuel cell power source in the comparison example 1 was the same as that in the reference example 1, except that the configuration of the liquid fuel supply part 200 was different. That is, as to the configuration of the liquid fuel supply part 20, the fuel power source used in the comparison example 1 was further provided therein with a water feed pump 210, a high concentration methanol aqueous solution feed pump 220, a methanol aqueous solution concentration adjusting container 230, a methanol concentration sensor 240 and a DMFC supply pump 250. The piezoelectric pump shown in FIG. 6 was used as pumps used in the comparison example. In a method of adjusting the concentration of the methanol aqueous solution fed to the fuel passage board 107 in the DMFC 100, the supply quantities of the water and the methanol aqueous solution fed to the methanol aqueous solution concentration adjusting container 230 was controlled with the use of the water feed pump 210 and the high concentration methanol aqueous solution feed pump 220 connected direct to the water container 21 and the methanol aqueous solution container 220 in accordance with a concentration detected by the methanol concentration sensor 240.

(2) Test Method

The fuel cell power sources used in the reference examples 1 to 14 and the comparison example 1 were tested under the following condition and then evaluated. That is, the methanol aqueous solution was fed to the anode at a flow rate of 0.2 ml/min with its concentration being maintained at 2M. The air was fed to the cathode at a flow rate of 500 ml/min. Then the evaluation of the fuel cell power source were made being based upon:

(a) voltage-current characteristic (the temperature of the DMFC was set to 70 deg.C.) and

(b) continuous output power characteristic (the temperature of the DMFC was set to 70 deg.C., and the current density was set to 100 mA/cm²)

(3) Results:

The results of evaluation of characteristics (a) and (b) will be explained hereinbelow in the order of the reference examples 1 to 14 and the comparison example 1.

### REFERENCE EXAMPLE 1

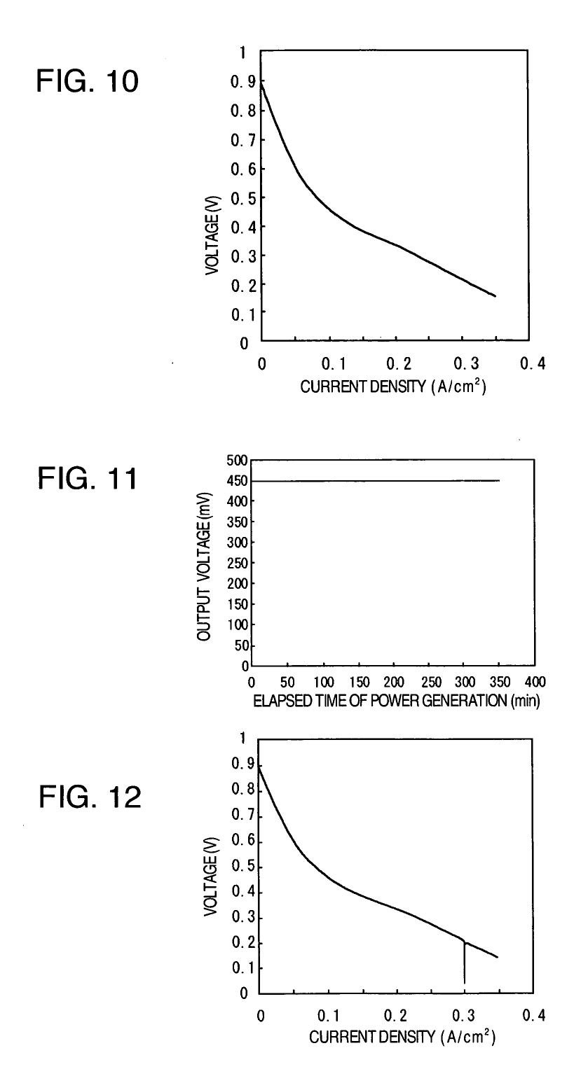

FIG. 10 shows the voltage-current characteristic of the DMFC. As shown in FIG. 10, the output voltage of the DMFC at a current density of 100 mA/cm² was 450 mV. Referring to FIG. 11 which shows the variation of the output voltage with time during continuous operation at a current density of 100 mA/cm², the output voltage of the DMFC were maintained to be constant even after 5 hour operation and the output voltage was never dropped.

It is noted that the results of voltage-current characteristics of the DMFC and the behaviors of variation of the output voltage with time after continuous operation at a current density of 100 mA/cm² were substantially equal to those shown in FIGS. 10 and 11 as to the reference example 1, even in the reference examples 2 to 14, and accordingly, the figures which shows the results and the behaviors in the reference examples 2 to 14 will be omitted. Thus, the output voltage of the DMFC at a current density of 100 mA/cm², and the time of possible continuous power generation at a current density of will be shown as to the reference examples 2 to 14.

### REFERENCE EXAMPLE 2

The output voltage of the DMFC at a current density of 100 mA/cm² was 470 mV in view of the result of the voltage-current characteristic of the DMFC. The time of possible continuous operation of the DMFC at a current density of 100 mA/cm² was 8 hours.

### REFERENCE EXAMPLE 3

The output voltage of the DMFC at a current density of 100 mA/cm² was 480 mV in view of the result of the voltage-current characteristic of the DMFC. The time of possible continuous operation of the DMFC at a current density of 100 mA/cm² was 16 hours.

### REFERENCE EXAMPLE 4

The output voltage of the DMFC at a current density of 100 mA/cm² was 480 mV in view of the result of the voltage-current characteristic of the DMFC. The time of possible continuous operation of the DMFC at a current density of 100 mA/cm² was 5 hours.

### REFERENCE EXAMPLE 5

The output voltage of the DMFC at a current density of 100 mA/cm² was 480 mV in view of the result of the voltage-current characteristic of the DMFC. The time of possible continuous operation of the DMFC at a current density of 100 mA/cm² was 16 hours.

### REFERENCE EXAMPLE 6

The output voltage of the DMFC at a current density of 100 mA/cm² was 480 mV in view of the result of the voltage-current characteristic of the DMFC. The time of possible continuous operation of the DMFC at a current density of 100 mA/cm² was 16 hours.

### REFERENCE EXAMPLE 7

The output voltage of the DMFC at a current density of 100 mA/cm² was 530 mV in view of the result of the voltage-current characteristic of the DMFC. The time of possible continuous operation of the DMFC at a current density of 100 mA/cm² was 14.4 hours.

### REFERENCE EXAMPLE 8

The output voltage of the DMFC at a current density of 100 mA/cm² was 550 mV in view of the result of the voltage-current characteristic of the DMFC. The time of possible continuous operation of the DMFC at a current density of 100 mA/cm² was 14.4 hours.

### REFERENCE EXAMPLE 9

The output voltage of the DMFC at a current density of 100 mA/cm² was 570 mV in view of the result of the voltage-current characteristic of the DMFC. The time of possible continuous operation of the DMFC at a current density of 100 mA/cm² was 14.4 hours.

### REFERENCE EXAMPLE 10

The output voltage of the DMFC at a current density of 100 mA/cm² was 570 mV in view of the result of the voltage-current characteristic of the DMFC. The time of possible continuous operation of the DMFC at a current density of 100 mA/cm² was 14.4 hours.

### REFERENCE EXAMPLE 11

The output voltage of the DMFC at a current density of 100 mA/cm² was 580 mV in view of the result of the voltage-current characteristic of the DMFC. The time of possible continuous operation of the DMFC at a current density of 100 mA/cm² was 14.4 hours.

### REFERENCE EXAMPLE 12

The output voltage of the DMFC at a current density of 100 mA/cm² was 620 mV in view of the result of the voltage-current characteristic of the DMFC. The time of possible continuous operation of the DMFC at a current density of 100 mA/cm² was 14.4 hours.

### REFERENCE EXAMPLE 13

The output voltage of the DMFC at a current density of 100 mA/cm² was 640 mV in view of the result of the voltage-current characteristic of the DMFC. The time of possible continuous operation of the DMFC at a current density of 100 mA/cm² was 14.4 hours.

### REFERENCE EXAMPLE 14

The output voltage of the DMFC at a current density of 100 mA/cm² was 650 mV in view of the result of the voltage-current characteristic of the DMFC. The time of possible continuous operation of the DMFC at a current-density of 100 mA/cm² was 14.4 hours.

### COMPARISON EXAMPLE 1

FIG. 10 shows the voltage-current characteristic of the DMFC. As shown, the output voltage of the DMFC at a current density of 100 mA/cm² was 450 mV. Referring to FIG. 11 which shows variation of the output voltage with time after 5 hour power generation at a current density of 100 mA/cm², the output voltage of the DMFC caused such a problem that the output voltage was once dropped since the supply of the methanol aqueous solution as a fuel to the anode becomes unstable due to carbonic acid gas produced after 36 min. or 63 min. elapsed from a start of operation of the fuel power source. Further, after 300 hours elapsed, large gas bubbles of carbonic acid gas were produced so as to hinder the supply of the methanol aqueous solution and to greatly lower the output voltage. The output voltages of the DMFCs at a current density of 100 mA/cm² and times of the possible continuous power generation at a current density of 100 mA/cm² are summarized in Table 1.

TABLE 1

| | Output | Possibility of 5 | Continuous |
|---|---|---|---|
| | Voltage | hour continuous | Operation |
| | (mV) | operation | Time |
| Ref. Ex. 1 | 450 | YES | 5 |
| Ref. EX. 2 | 470 | YES | 8 |
| Ref. Ex. 3 | 480 | YES | ↑ |
| Ref. Ex. 4 | 480 | YES | 16 |
| Ref. Ex. 5 | 480 | YES | ↑ |
| Ref. Ex. 6 | 480 | YES | ↑ |
| Ref. EX. 7 | 530 | YES | 14.4 |
| Ref. Ex. 8 | 550 | YES | ↑ |
| Ref. Ex. 9 | 570 | YES | ↑ |
| Ref. Ex. 10 | 570 | YES | ↑ |
| Ref. Ex. 11 | 580 | YES | ↑ |
| Ref. Ex. 12 | 620 | YES | ↑ |
| Ref. Ex. 13 | 640 | YES | ↑ |
| Ref. Ex. 14 | 650 | YES | ↑ |
| Com. Ex. 1 | 450 | NO | Less than 5 |

Note:
The output voltage was obtained at a current density of 100 mA/cm².

It can be understood from results listed in Table 1 and FIGS. 8 to 12 that the reference examples 1 to 14 exhibit the following technical effects and advantages.

### REFERENCE EXAMPLE 1

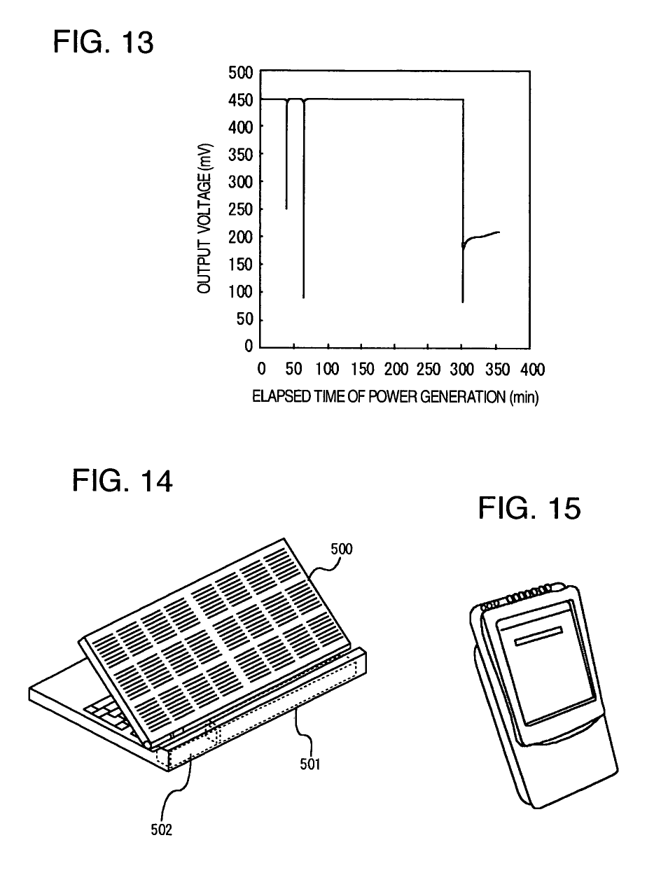

By comparing between the result of the voltage-current characteristic of the DMFC in the reference example 1 shown in FIG. 10 and the result of the voltage-current characteristic of the DMFC in the comparison example 1 shown in FIG. 13, the voltage-current characteristics of both DMFCs were substantially identical with each other, and the output voltage at the current density of 100 mA/cm² of both were 450 mV.

By comparing the relationship between the time of continuous power generation of the DMFC in the reference example 1 shown in FIG. 11 and the output voltage thereof with the relationship between the time of continuous power generation of the fuel cell power source in the comparison example 1 shown in FIG. 13 and the output voltage thereof, the output voltage was stable during 5 hour continuous power generation of the DMFC in the reference example 1 and did never drop. Meanwhile, the output voltage in the comparison example 1 was unstable during 5 hour power generation, and dropped. The reason is such that in the reference example 1, pulsation is applied to the methanol aqueous solution when it is fed to the DMFC so that carbonic acid gas produced in the anode can be smoothly removed from the DMFC, and on the other hand, in the comparison example 1, no pulsation is applied to the methanol aqueous solution when it is fed into the DMFC, and accordingly, carbonic acid gas produced in the anode cannot be smoothly removed from the fuel cell power source.

Thus, the result of comparison between the reference example 1 and the comparison example 1 shows that since the methanol aqueous solution and the water are fed through time-sharing with the use of the solenoid valve so as to reduce the number of liquid feed pumps to one in the fuel cell power source in the reference example 1, in comparison with the comparison example 1 in which three liquid feed pumps are used, the space saving and the weight reduction of the fuel cell power source can be made in the reference example 1. Further, in the fuel cell power source in the reference example 1, since pulsation is applied to the methanol aqueous solution when it is fed to the DMFC, so as to smoothly remove carbonic acid gas produced in the anode, from the DMFC, the power generation can be continued with a stable output voltage (450 mV).

### REFERENCE EXAMPLE 2

By comparing the result of the voltage-current characteristic of the DMFC in the reference example 2 with the result of the voltage-current characteristic of the DMFC in the reference example 1, the output voltage of the DMFC in the reference example 2 at the current density of 100 mA/cm² is 470 mV which is higher than that in the reference example 1 by about 20 mV. By comparing the relationship between the time of continuous power generation of the DMFC in the reference example 2 and the output voltage thereof with the relationship between the time of continuous power generation of the DMFC in the reference example 1 and the output voltage thereof, the time of continuous power generation of the fuel cell power source with a stable output voltage (470 mV) in the reference example 2 is 8 hours, which is longer than the time (5 hours) of continuous power generation in the reference example 1 by 3 hours. As stated above, the result of comparison between the reference example 1 and the reference example 2 shows that the output voltage of the DMFC at the current density of 100 mA/cm² was higher in the reference example 2 than that in the reference example 1 by about 20 mV, and the time of possible continuous power generation with a stable output voltage is longer in the reference example 2 than that in the reference example 1 by 3 hours, in addition to the advantages which can be obtained in the reference example 1 in comparison with the comparison example 1. This technical effects are due to the hydrophilic process applied to the carbon powder in the anode diffusion layer.

That is, with this hydrophilic process, since the anode diffusion layer becomes wettable with respect to the aqueous methanol aqueous solution, the methanol aqueous solution can smoothly penetrate into the anode diffusion layer 103 by a larger quantity, and accordingly, the reaction can be promoted, resulting in a high output voltage. Further, with this hydrophilic process, since air bubbles of carbonic acid gas produced in the anode can be prevented from growing into a larger size, but can be discharged from the anode diffusion layer 105 with a fine size as it is, the supply of the methanol aqueous solution to the anode can be smoothly made, thereby it is possible to carry out long continuous power generation with a stable voltage.

### REFERENCE EXAMPLE 3

By comparing the result of the voltage-current characteristic of the DMFC in the reference example 3 with the result of the voltage-current characteristic of the DMFC in the reference example 2, the output voltage of the DMFC in the reference example 3 at the current density of 100 mA/cm² is 480 mV which is higher than that in the reference example 2 by about 10 mV. Then, by comparing the relationship between the time of continuous power generation of the DMFC in the reference example 3 and the output voltage thereof with the relationship between the time of continuous power generation of the DMFC in the reference example 2 and the output voltage thereof, the time of possible continuous power generation of the fuel cell power source with a stable output voltage is identical between both cases as stated above, the result of comparison between the reference example 3 and the reference example 2 shows that the output voltage of the DMFC at the current density of 100 mA/cm² was higher in the reference example 2 than that in the reference example 1 by about 10 mV, in addition to the advantages which can be obtained in the reference example 2 in comparison with the reference example 1. This technical effects are due to the hydrophilic process applied further in the reference example 3 to the carbon cloth carrier of the anode diffusion layer used in the reference example 2. That is, with this hydrophilic process, since the anode diffusion layer becomes wettable with respect to the aqueous methanol aqueous solution, the methanol aqueous solution can smoothly penetrate into the anode diffusion layer 103 by a larger quantity, and accordingly, the reaction can be promoted, resulting in a high output voltage. Further, with this hydrophilic process, since air bubbles of carbonic acid gas produced in the anode can be prevented from growing into a larger size, but can be discharged from the anode diffusion layer 105 with a fine size as it is, the supply of the methanol aqueous solution to the anode can be smoothly made, thereby it is possible to carry out long continuous power generation with a stable voltage.

### REFERENCE EXAMPLE 4

By comparing the result of the voltage-current characteristic of the DMFC in the reference example 4 with the result of the voltage-current characteristic of the DMFC in the reference example 3, the output voltage of the DMFC in the reference example 4 at the current density of 100 mA/cm² is 480 mV which is equal to that in the reference example 3 by about 10 mV. Then, by comparing the relationship between the time of continuous power generation of the DMFC in the reference example 4 and the output voltage thereof with the relationship between the time of continuous power generation of the DMFC in the reference example 3 and the output voltage thereof, the time of possible continuous power generation of the fuel cell power source with a stable output voltage in the embodiment 4 is 18 hours, which is two times as long as that in the reference example 3.

Thus, the result of comparison between the reference example 3 and the reference example1 16 shows that the time of possible continuous power generation with a stable output voltage is longer than that in the reference example 3 by two times, in addition to the advantages which can be obtained in the reference example 3 in comparison with the comparison example 2. This technical effects is caused by replacing the binder between the solid polymer electrolyte membrane and the anode with the hydrocarbon group electrolyte membrane since this hydrocarbon group electrolyte membrane has an ion conductivity which is higher (that is, the internal resistance of the EMFC is lower) than that of the fluorine group electrolyte membrane used in the reference example 3, and since the methanol which causes cross-over is small, that is, the higher the ion conductivity of the solid polymer electrolyte membrane, the lower the internal resistance of the fuel cell, thereby it is possible to increase the output voltage. Further, the smaller the quantity of the methanol which causes cross-over, the lower the variation of the concentration of methanol in the methanol aqueous solution, thereby it is possible to enhance the stability of the fuel cell power source and to contribute to enhancement of the availability of the fuel.

### REFERENCE EXAMPLE 5

By comparing the result of the voltage-current characteristic of the DMFC in the reference example 5 with the result of the voltage-current characteristic of the DMFC in the reference example 4, the output voltage of the DMFC in the reference example 4 at the current density of 100 mA/cm² is 480 mV which is equal to that in the reference example 4. Then, by comparing the relationship between the time of continuous power generation of the DMFC in the reference example 5 and the output voltage thereof with the relationship between the time of continuous power generation of the DMFC in the reference example 4 and the output voltage thereof, the time of possible continuous power generation of the fuel cell power source with a stable output voltage in the reference example 5 is equal to that in the reference example 4. The result of comparison between the reference example 5 and the reference example 4 shows that the reference example 5 can offer technical effects the same as that in the reference example 4 with only using the time-sharing type piezoelectric liquid feed pump but without using the solenoid valve for adjusting the concentration of the methanol aqueous solution fed to the DMFC.

### REFERENCE EXAMPLE 6

By comparing the result of the voltage-current characteristic of the DMFC in the reference example 6 with the result of the voltage-current characteristic of the DMFC in the reference example 5, the output voltage of the DMFC in the reference example 6 at the current density of 100 mA/cm² is 480 mV which is equal to that in the reference example 5.

Then, by comparing the relationship between the time of continuous power generation of the DMFC in the reference example 6 and the output voltage thereof with the relationship between the time of continuous power generation of the DMFC in the reference example 5 and the output voltage thereof, the time of possible continuous power generation of the fuel cell power source with a stable output voltage in the reference example 6 is equal to that in the reference example 5.

The thus result of comparison between the reference example 6 and the reference example 5 shows that the reference example 6 can offer technical effects similar to those in the reference example 5 although the liquid feed is maid by the time-sharing type piezoelectric liquid feed pump having the left and right partition wall chambers with different volumes without using the solenoid valve for adjusting the concentration of the methanol aqueous solution fed to the DMFC.

### REFERENCE EXAMPLE 7

By comparing the result of the voltage-current characteristic of the DMFC in the reference example 7 with the result of the voltage-current characteristic of the DMFC in the reference example 6, the output voltage of the DMFC in the reference example 7 at the current density of 100 mA/cm² is 530 mV which is higher than that in the reference example 1 by about 50 mV.

Then, by comparing the relationship between the time of continuous power generation of the DMFC in the reference example 7 and the output voltage thereof with the relationship between the time of continuous power generation of the DMFC in the reference example 6 and the output voltage thereof, the time of possible continuous power generation of the fuel cell power source with a stable output voltage in the reference example 7 is 14.4 hours which is slightly shorter than that in the reference example 6. As stated above, the result of comparison between the reference example 7 and the reference example 6 shows that the output voltage of the DMFC at the current density of 100 mA/cm² was higher in the reference example 7 than that in the reference example 6 by about 50 mV, in addition to the advantages which can be obtained in the reference example 6 in comparison with the reference examples 1 to 3. Further, although the time of possible continuous power generation with a stable output voltage is slightly shorter than that in the reference example 6, technical effects obtained in the reference example 7 substantially the same as those in the reference example 6 can be obtained.

This technical effects are caused by such a fact that the thickness of the anode catalyst layer is increased from 25 μm to 40 μm so as to increase the area where the methanol aqueous solution makes contact with the anode catalyst layer 103, resulting in promotion of the reaction between the methanol and the water in the anode catalyst layer 103, thereby it is possible to increase the output voltage. Further, the promotion of the reaction due to an increase in the contact area between the methanol aqueous solution and the anode catalyst layer can contribute to the enhancement of the availability of the fuel. It is noted, the reason why the thickness of the cathode catalyst layer is decreased is such that the quantity of the cathode catalyst is decreased to a value which can prevent the output power of the fuel cell from lowering, in order to reduce the total quantity of platinum for reducing the total cost, in view of prevention of increase of the DMFC and expensive cost of the catalyst such as platinum.

### REFERENCE EXAMPLE 8

By comparing the result of the voltage-current characteristic of the DMFC in the reference example 8 with the result of the voltage-current characteristic of the DMFC in the reference example 7, the output voltage of the DMFC in the reference example 8 at the current density of 100 mA/cm² is 550 mV which is higher than that in the reference example 1 by about 20 mV. Then, by comparing the relationship between the time of continuous power generation of the DMFC in the reference example 8 and the output voltage thereof with the relationship between the time of continuous power generation of the DMFC in the reference example 7 and the output voltage thereof, the time of possible continuous power generation of the fuel cell power source with a stable output voltage in the reference example 8 is equal to that in the reference example 7.

Thus the result of comparison between the reference example 8 and the reference example 7 shows that the output voltage of the DMFC at the current density of 100 mA/cm² is higher in the reference example 8 than that in the reference example 7 by about 20 mV. The reason why the output voltage can be increased, is such that the carbon powder in the anode diffusion layer is subjected to the hydrophilic process. That is, since the anode diffusion layer becomes wettable with respect to the methanol aqueous solution, the methanol aqueous solution smoothly penetrates into the anode catalyst layer 103 by a larger quantity. Thus, the reaction between the methanol and the water is promoted in the anode catalyst layer 103, and accordingly, the output voltage can be increased.

### REFERENCE EXAMPLE 9

By comparing the result of the voltage-current characteristic of the DMFC in the reference example 9 with the result of the voltage-current characteristic of the DMFC in the reference example 8, the output voltage of the DMFC in the reference example 9 at the current density of 100 mA/cm² is 570 mV which is higher than that in the reference example 8 by about 20 mV. Then, by comparing the relationship between the time of continuous power generation of the DMFC in the reference example 9 and the output voltage thereof with the relationship between the time of continuous power generation of the DMFC in the reference example 8 and the output voltage thereof, the time of possible continuous power generation of the fuel cell power source with a stable output voltage in the reference example 9 is equal to that in the reference example 8.

Thus the result of comparison between the reference example 9 and the reference example 8 shows that the output voltage of the DMFC at the current density of 100 mA/cm² is higher in the reference example 9 than that in the reference example 8 by about 20 mV. The reason why the output voltage can be increased is such that the carbon cloth of the anode diffusion layer subjected to the hydrophilic process is wettable with respect to the methanol aqueous solution which can relatively smoothly penetrate by a larger quantity into the anode catalyst layer.

### REFERENCE EXAMPLE 10

By comparing the result of the voltage-current characteristic of the DMFC in the reference example 10 with the result of the voltage-current characteristic of the DMFC in the reference example 9, the output voltage of the DMFC in the reference example 10 at the current density of 100 mA/cm² is 570 mV which is equal to that in the reference example 9.

Then, by comparing the relationship between the time of continuous power generation of the DMFC in the reference example 10 and the output voltage thereof with the relationship between the time of continuous power generation of the DMFC in the reference example 9 and the output voltage thereof, the time of possible continuous power generation of the fuel cell power source with a stable output voltage in the reference example 10 is equal to that in the reference example 9.

As the result of comparison between the reference example 10 and the reference example 9, the reference example 10 can exhibit technical effects similar to those in the reference example 9 due to such an effect that the carbon paper is used in the anode diffusion layer and the cathode diffusion layer, instead of the carbon cloth carrier even though the anode diffusion layer in the reference example 10 is not subjected to the hydrophilic process. This fact shows that the carbon paper is excellent for the carrier in the diffusion layer, in comparison with the carbon cloth.

### REFERENCE EXAMPLE 11

By comparing the result of the voltage-current characteristic of the DMFC in the reference example 11 with the result of the voltage-current characteristic of the DMFC in the reference example 10, the output voltage of the DMFC in the reference example 11 at the current density of 100 mA/cm² is 580 mV which is higher than that in the reference example 10 by about 10 mV. Then, by comparing the relationship between the time of continuous power generation of the DMFC in the reference example 11 and the output voltage thereof with the relationship between the time of continuous power generation of the DMFC in the reference example 10 and the output voltage thereof, the time of possible continuous power generation of the fuel cell power source with a stable output voltage in the reference example 11 is equal to that in the reference example 10.

Thus the result of comparison between the reference example 11 and the reference example 10 shows that the output voltage of the DMFC at the current density of 100 mA/cm² is higher in the reference example 11 than that in the reference example 10 by about 10 mV, in addition to the technical effects obtained in the reference example 10 in comparison with the reference example 9. The reason why the output voltage can be increased is such that the material of the binder of the cathode diffusion layer is changed from the fluororesin group electrolyte membrane into the hydrocarbon group electrolyte membrane so as to further increase the ion conductivity, and as well the contact area between the electrolytic solution and the cathode catalyst is increased by the hydrophilic process for the carbon powder carrier of the cathode catalyst layer so as to further promote the reaction, resulting in the increase of the output power.

### REFERENCE EXAMPLE 12

By comparing the result of the voltage-current characteristic of the DMFC in the reference example 12 with the result of the voltage-current characteristic of the DMFC in the reference example 11, the output voltage of the DMFC in the reference example 12 at the current density of 100 mA/cm² is 620 mV which is higher than that in the reference example 11 by about 40 mV. Then, by comparing the relationship between the time of continuous power generation of the DMFC in the reference example 12 and the output voltage thereof with the relationship between the time of continuous power generation of the DMFC in the reference example 11 and the output voltage thereof, the time of possible continuous power generation of the fuel cell power source with a stable output voltage in the reference example 12 is equal to that in the reference example 11.

Thus the result of comparison between the reference example 12 and the reference example 11 shows that the output voltage of the DMFC at the current density of 100 mA/cm² is higher in the reference example 12 than that in the reference example 11 by about 40 mV, in addition to the technical effects obtained in the reference example 11 in comparison with the reference example 10. This technical effect is such that the thickness of the anode catalyst layer is increased from 40 to 60 μm so as to further increase the contact area between the methanol aqueous solution and the anode catalyst layer, resulting in promotion of the reaction between the methanol and the water in the anode catalyst layer 103, thereby it is possible to increase the output voltage.

### REFERENCE EXAMPLE 13

By comparing the result of the voltage-current characteristic of the DMFC in the reference example 13 with the result of the voltage-current characteristic of the DMFC in the reference example 12, the output voltage of the DMFC in the reference example 13 at the current density of 100 mA/cm² is 640 mV which is higher than that in the reference example 12 by about 20 mV. Then, by comparing the relationship between the time of continuous power generation of the DMFC in the reference example 13 and the output voltage thereof with the relationship between the time of continuous power generation of the DMFC in the reference example 12 and the output voltage thereof, the time of possible continuous power generation of the fuel cell power source with a stable output voltage in the reference example 13 is equal to that in the reference example 12.

Thus the result of comparison between the reference example 13 and the reference example 12 shows that the output voltage of the DMFC at the current density of 100 mA/cm² is higher in the reference example 13 than that in the reference example 12 by about 20 mV, in addition to the technical effects obtained in the reference example 12 in comparison with the reference example 11. This technical effect is such that the thickness of the anode catalyst layer is increased from 60 to 80 μm so as to further increase the contact area between the methanol aqueous solution and the anode catalyst layer, resulting in promotion of the reaction between the methanol and the water in the anode catalyst layer 103, thereby it is possible to increase the output voltage.

### REFERENCE EXAMPLE 13

By comparing the result of the voltage-current characteristic of the DMFC in the reference example 14 with the result of the voltage-current characteristic of the DMFC in the reference example 13, the output voltage of the DMFC in the reference example 14 at the current density of 100 mA/cm² is 650 mV which is higher than that in the reference example 12 by about 10 mV. Then, by comparing the relationship between the time of continuous power generation of the DMFC in the reference example 14 and the output voltage thereof with the relationship between the time of continuous power generation of the DMFC in the reference example 13 and the output voltage thereof, the time of possible continuous power generation of the fuel cell power source with a stable output voltage in the reference example 14 is equal to that in the reference example 13.

### REFERENCE EXAMPLE 14

Thus the result of comparison between the reference example 14 and the reference example 12 shows that the output voltage of the DMFC at the current density of 100 mA/cm² is higher in the reference example 14 than that in the reference example 13 by about 10 mV, in addition to the technical effects obtained in the reference example 13 in comparison with the reference example 12. This technical effect is such that the thickness of the anode catalyst layer is increased from 60 to 80 μm so as to further increase the contact area between the methanol aqueous solution and the anode catalyst layer, resulting in promotion of the reaction between the methanol and the water in the anode catalyst layer 103, thereby it is possible to increase the output voltage. Incidentally, it has been found that the output voltage cannot be increased in proportion to an increase in the thickness of the anode catalyst layer 103 even though the thickness of the anode catalyst is increased from the instant thickness.

Further, the features of the present invention will be evaluated with reference to reference examples 15 to 28 and the comparison example 2 although the present invention should not be limited to these reference example.

### REFERENCE EXAMPLE 15

The configuration of a fuel cell power source in an embodiment 15 was the same as that of the fuel cell power source 1 shown in FIG. 1. Detailed explanation will be hereinbelow made in particular of a solid polymer electrolyte membrane 102, an anode catalyst layer 103, a cathode catalyst layer 104, an anode diffusion layer 105, a cathode diffusion layer 106, a fuel passage board 107 and an air passage board 111 which constitute a DMFC 100 used in the embodiment 15, in succession.

As the solid polymer electrolyte membrane 102, a polyperflurocarbon sulfonic acid membrane (Trade Mark: Nafion 117 manufactured by Dupon Co.) was used. The anode catalyst layer 103 was formed by applying a slurry obtained by preparing catalyst powder in which 50 wt. % of platinum/ruthenium particles having an atom ratio of 1/1 between platinum and ruthenium was dispersed to and carried by carbon carriers, and a water/alcohol mixture solution (a mixture in which water as a solovent, isopropanol and normal propanol which were mixed by a weight ratio of 20:40:40 was used, manufactured by Fluka Chemika Co.) into whic polyperfluorocabon sulfonic acid electrolyte as a binder was solved so as to have 0.5 wt. % of concentration, on a polytetrafluoroethylene film with the use of a screen printing process so as to form a porous catalyst layer having a width of 10 mm×20 mm, a thickness of about 80 μm after drying. At this stage, the degree of deposit was 6 mg/cm². The cathode catalyst layer 104 was formed by applying a slurry obtained by preparing a catalyst powder in which 30 wt. % of platinum particles was carried by carbon carriers, and a water/alcohol mixture solution (a mixture in which water as a solvent, isopropanol and normal propanol were mixed by a weight ratio of 20:40:40 was used, manufactured by Fluka Chemika Co.) of 5 wt. % of concentration of Nafion 117, on a polytetrafluoroethylene film with the use of a screen printing process so as to form a porous catalyst layer having a width of 10 mm, a length of 20 mm and a thickness of about 25 μm after drying. The degree of deposit of catalyst was 3 mg/cm².

Next, explanation will be made the preparation of the MEA. The MEA electrode is obtained by at first (1) joining the anode catalyst layer 103 to one side surface of the solid polymer electrode membrane 100, and (2) joining the cathode catalyst layer 104 to the surface of the solid polymer electrolyte membrane 102 on the side remote from the anode catalyst layer 103. This anode catalyst layer 103 is superposed on a power generation part (electrode) of the solid polymer electrolyte membrane 102 after the anode catalyst layer 103 is impregnated over its surface with a water/alcohol mixture solution (a mixture in which water as a solvent, isopropanol and normal propanol which were mixed by a weight ratio of 20:40:40 was used, manufactured by Fluka Chemika Co.) of 5 wt. % of Nafion 117 by about 0.5 ml. Then it is dried at a temperature of 80 deg.C. for 3 hours under a load of about 1 kg. The cathode catalyst layer 104 is joined to the solid polymer electrolyte membrane 102 as follows: This cathode catalyst layer 104 is superposed on a power generation part (electrode) of the solid polymer electrolyte membrane 102 on the side remote from the side on which the anode catalyst layer 103 is joined after the cathode catalyst layer 104 is impregnated over its surface with a water/alcohol mixture solution (a mixture in which water as a solvent, isopropanol and normal propanol which were mixed by a weight ratio of 20:40:40 was used, manufactured by Fluka Chemika Co.) of 5 wt. % of Nafion 117 by about 0.5 ml. Then it is dried at a temperature of 80 deg.C. for 3 hours under a load of about 1 kg.

Next, explanation will be made of a method of preparing the anode diffusion layer 105 and the cathode diffusion layer 106. Carbon powder was added there in with an aqueous dispersion of repellent polytetrafluoroethylene fine particles (Teflon dispersion D-1 manufactured by Daikin Industrial Co.) so as to obtain 40 wt. % concentration after calcination, and was kneaded so as to obtain a paste. Then, the paste was built up on one surface of a carbon cloth carrier having a thickness of 350 μm and a void rate of 87% up to a thickness of 20 μm, and after drying at a room temperature, was calcined at a temperature of 270 deg. for 3 hours so as to obtain a carbon sheet. The carbon sheet was cut into pieces having a size equal to that of the anode electrode of the MEA electrode as stated above. Thus, the anode diffusion layer 105 was obtained. Carbon powder r was added in an aqueous dispersion of repellent polytetrafluoroethylene fine particles (Teflon dispersion D-1 manufactured by Daikin Industrial Co.) so as to obtain 40 wt. % concentration after calcination, and was kneaded so as to obtain a paste. Then, the paste was built up on one surface of a carbon cloth carrier having a thickness of 350 μm and a void rate of 87% up to a thickness of 20 μm, and after drying at a room temperature, was calcined at a temperature of 270 deg. for 3 hours so as to obtain a carbon sheet. The carbon sheet was cut into pieces having a size equal to that of the cathode electrode of the MEA as stated above. Thus, the cathode diffusion layer 105 was obtained.

The MEA electrode in which the anode catalyst layer 103 and the cathode catalyst layer 104 are integrally joined to both surfaces of the solid polymer electrolyte membrane 102, and the anode diffusion layer 105 and the cathode diffusion layer 106 are made into close contact with the surfaces of the anode catalyst layer 103 and the cathode catalyst layer 104, respectively. The air passage board 111 is arranged outside of the cathode diffusion layer 105, and formed therein with the air passage 114 having the air supply port 106 and the air discharge port 113. The air is fed by the air blower 51 in the oxidant gas supply part 50. Meanwhile, the fuel passage board 107 is arranged outside of the anode diffusion layer 105, and formed therein with the fuel passage 110 having the fuel supply port 108 and the fuel discharge port 109. The methanol aqueous solution fed to the fuel passage board 107 is controlled so as to have a concentration in an appropriate range by the control part 30. This control is made in such a way that the timing of the time-sharing of the solenoid valve 24 which is provided on the inlet side of the liquid feed pump 23 and which changes over between the passage connecting the outlet port of the methanol aqueous solution container 22 to the inlet port of the liquid feed pump 23 (the pump shown in FIG. 6) and the passage connecting the outlet port of the water container 21 to the inlet port of the liquid feed pump 23. It is noted that the timing was controlled so as to easily cause pulsation by changing over the solenoid valve 24 with the timing of 50 to 0.2 cycles per second in order to smoothly discharge carbonic acid gas produced in the anode through the reaction exhibited by the chemical formula (1), from the cell.

It is noted that explanation of fuel cell power sources used in the following reference examples 16 to 28 and a comparison example 2 will be explained as to distinct parts which are different from those explained in the reference example 1, that is, the explanation of the parts common to the reference example 1 will be omitted.

### REFERENCE EXAMPLE 16

20 g of carbon powder used in the reference example 15 was mixed with 200 ml of fuming sulfuric acid (having a concentration of 60%) in a 300 ml flask, and was held under a stream of nitrogen with a temperature of 60 deg.C. being maintained for 2 days so as to be reacted. The color of the reacted liquid was changed from black into brown. Then, cooling was continued until the temperature of the flask was lowered to a room temperature, and then, the reacted liquid was gradually added under agitation in the flask in which 600 ml of distilled water was present while it was cooled by ice, and after reacted liquid was added in its entirety, it was filtered. The thus obtained filtered deposition was washed sufficiently by distilled water until the detergent becomes neutral. Thereafter, the deposition was washed with methanol and diethyelether in the mentioned order, and was dried under vacuum at a temperature of 40 deg.C. so as to obtain a derivative of carbon powder. This carbon powder was measured by an infrared spectrometer, and as a result, optical absorption were found at 1,255 cm⁻¹ and 1,413 cm⁻¹, being based upon —OSO₃H group. Further, optical absorption was also found at 1,049 cm⁻¹, being based upon —OH group. This results show that —OSO₃H group and —OH group were introduced on the surface of the carbon powder treated with the fuming sulfuric acid. The contact angle between the carbon powder treated with the fuming sulfuric acid and the methanol aqueous solution is smaller than that between a carbon powder not treated with fuming sulfuric acid and the methanol aqueous solution, that is, it is hydrophilic. Further, the carbon powder treated with fuming sulfuric acid exhibited an excellent conductivity in comparison with the carbon powder not treated with fuming sulfuric acid. This carbon powder treated with fuming sulfuric acid was added in a water/alcohol mixture solution of 5 wt. of Nafion 117 (a solvent obtained by mixing water, isopropanol and normalpropanol with a weight ratio of 20:40:40, manfuactued by Fluka Chemika Co.) so as to obtain a paste which was then build up on one surface of a carbon cloth having a thickness of about 350 μm and a void rate of 87% and used for the carrier of the anode diffusion layer 107, up to a thickness of about 20 μm, and which was then dried at a temperature of 100 deg.C. so as to obtain a carbon sheet. The thus obtained sheet was cut into pieces having a size the same at that of the above-mentioned MEA electrode. Thus, the anode diffusion layer 106 was obtained. The fuel cell power source having a configuration the same as that in the reference example 16, except that mentioned above, was used so as to carry out tests.

### REFERENCE EXAMPLE 17

The carbon cloth (used in the reference example 15) having a thickness of about 350 μm and a void rate of 87% was soaked in a flask containing therein fuming sulfuric acid (having a concentration of 60%) so as to be treated, similar to the carbon powder treated with fuming sulfuric acid in the reference example 16. As a result, the carbon cloth treated with fuming sulfuric acid was introduced onto its outer surface with —OSO₃ group and —OH group, and accordingly, it was excellent in hydrophilicity and conductivity. The fuel cell power source having a configuration the same as that in the reference example 16, except that the carbon cloth treated with fuming sulfuric acid was used as the carrier of the anode diffusion layer 105, was used and tests were carried out.

### REFERENCE EXAMPLE 18

In stead of polyperfluoro carbon sulfonic acid membrane in the solid polymer electrolyte membrane in the embodiment 15, sulfomethyl polyether sulfonic acid hydrogen group electrolyte was used. Further, 30 wt. % of sulfomethyl polyether sulfonic acid electrolyte was used as the binder in the anode diffusion layer 103. Except the above-mentioned configuration, the fuel cell power source having a configuration the same as that in the reference example 16 was used and test were carried out. In this case, the anode catalyst layer 103 were formed as follows: First, a catalyst powder in which fine particles of a platinum/ruthenium alloy having an atom ratio of 1/1 between platinum and ruthenium was dispersed in and carried on a carbon powder used for the carrier of the anode catalyst layer 103 was prepared. Then, a slurry composed of this catalyst powder, a water/alcohol solution of 30 wt. % of sulfomethylpolyether sulfonic acid hydrocarbon group electrolyte (a solvent obtained by mixing water, isopropanol and normalpropanol with a weight ratio of 20:40:40. Fulca manufactured by Chemica Co.), a dispersing agent and a repellent was prepared, and was build up on a polytetrafluoroethylene film by a screen printing process so as to obtain a porous catalyst layer having a thickness of about 80 μm, and this porous catalyst layer was used as the anode catalyst layer 103.

### REFERENCE EXAMPLE 19

A fuel cell power source having a configuration the same as that in the reference example 18, except that the concentration of the methanol aqueous solution fed to the DMFC used in the reference example 18 was carried out only by the time-sharing type piezoelectric liquid feed pump as shown in FIG. 7 with no use of the solenoid valve 24, was used so as to carry out tests.

### REFERENCE EXAMPLE 20

A fuel cell power source having a configuration the same as that in the reference example 19, except volumes of left and right partition wall chambers of the time-sharing type piezoelectric liquid feed pump are different from each other so that the volume of the partition wall chamber through which the water flows is two times as larger as that of the partition wall chamber through which the methanol aqueous solution flows, was used so as to carry out tests.

### REFERENCE EXAMPLE 21

A fuel cell power source having a configuration the same as that in the reference example 19, except the thickness of the anode catalyst layer 103 was changed from 80 μm to 150 μm and the thickness of the cathode catalyst layer 104 was changed from 50 μm to 25 μm, was used so as to carry out tests.

### REFERENCE EXAMPLE 22

A fuel cell power source having a configuration the same as that in the reference example 2, except that carbon powder used in the reference example 15 was treated with fuming sulfuric acid the same as that in the reference example 16, and the thus obtained hydrophilic carbon powder was used in the anode diffusion layer 105, was used so as to carry out tests.

### REFERENCE EXAMPLE 23

A fuel cell power source having a configuration the same as that in the reference example 22 except that the carbon cloth used in the reference example 17 was treated with fuming sulfuric acid which is the same as that in the reference example 17, and the thus obtained hydrophilic carbon cloth was used in the anode diffusion layer 105, was used so as to carry out tests.

### REFERENCE EXAMPLE 24

A fuel cell power source having a configuration the same as that in the reference example 22, except that instead of the carbon cloth used for carriers of the anode diffusion layer 105, a carbon paper was used for the carriers, was used so as to carry out tests.

### REFERENCE EXAMPLE 25

The cathode catalyst layer 104 used in the reference example 21 was formed as follow: At first, a catalyst powder in which 50 wt. % of a catalyst of fine particles of a platinum/ruthenium alloy having an atom ratio of 1/1 between platinum and ruthenium was dispersed in and carried on a carbon powder used for the carrier of the cathode diffusion layer 104 was prepared. Next, a slurry composed of this catalyst powder, a water/alcohol mixture solution of 30 wt. % of sulhomethylpolyether sulfonic hydrocarbon group electrolyte (a solvent obtained by mixing water, isopropanol and normalpropanol with a weight ratio of 20:40:40: Fulca manufactured by Chemica C.), a dispersing agent and a repellant was prepared, and was then build up on a polytetrafluoroethylene film by a screen printing process so as to form a porous catalyst layer having a thickness of about 25 μm. This porous catalyst layer was used as the cathode catalyst layer 104. Further, a carbon carrying carbon paper was used for the cathode diffusion layer 106. The fuel cell power source having a configuration the same as that in the reference example 24, except that the cathode catalyst layer 104 and the cathode diffusion layer 106 were replaced with those stated just above, was used so as to carry out tests.

### REFERENCE EXAMPLE 26

A fuel cell having a configuration the same as that in the reference example 25, except that the thickness of the anode catalyst layer 103 was changed from 150 to 200 μm and the thickness of the cathode catalyst layer 104 was changed from 25 to 15 μm was used so as to carry out test.

### REFERENCE EXAMPLE 27

A fuel cell power cell having a configuration the same as that in the reference example 26, except that the thickness of the anode catalyst layer 103 was changed from 200 to 100 μm, while the thickness of the cathode catalyst layer 106 was changed from 15 to 10 μm, and the carbon powder used in the reference example 15 was treated with fuming sulfuric acid the same as that in the reference example 16 so as to obtain a hydrophilic carbon powder which was then used as the carrier of the anode catalyst layer 103, was used so as to carry out tests.

### REFERENCE EXAMPLE 28

A fuel cell power cell having a configuration the same as that in the reference example 27, except that the thickness of the anode catalyst layer 103 was changed from 100 to 50 μm, was used so as to carry out tests, and the thickness of the cathode catalyst layer 104 was changed from 10 to 5 μm, was used so as to carry out tests.

### COMPARISON EXAMPLE 2

Referring to FIG. 15 which shows a configuration of a fuel cell power source used in a comparison example 2, the configuration of the fuel cell power source in the comparison example 2 was the same as that in the reference example 1, except that the configuration of the liquid fuel supply part 20 was different. That is, as to the configuration of the liquid fuel supply part 20, the fuel cell power source used in the comparison example 2 was further provided therein with a water feed pump 210, a high concentration methanol aqueous solution feed pump 220, a methanol aqueous solution concentration adjusting container 230, a methanol concentration sensor 240 and a DMFC supply pump 250. The piezoelectric pump shown in FIG. 6 was used as pumps used in the comparison example 2. In a method of adjusting the concentration of the methanol aqueous solution fed to the fuel passage board 107 in the DMFC 100, the supply quantities of the water and the methanol aqueous solution fed to the methanol aqueous solution concentration adjusting container 230 was controlled with the use of the water feed pump 210 and the high concentration methanol aqueous solution feed pump 220 connected direct to the water container 21 and the methanol aqueous solution container 220 in accordance with a concentration detected by the methanol concentration sensor 240.

(2) Test Method

The fuel cell power sources used in the reference examples 15 to 28 and the comparison example 2 were tested under the following condition and then evaluated. That is, the methanol aqueous solution was fed to the anode at a flow rate of 0.2 ml/min with its concentration being maintained at 2M. The air was fed to the cathode at a flow rate of 500 ml/min. Then the evaluation of the fuel cell power source were made being based upon: (i) voltage-current characteristic (the temperature of the DMFC was set to 70 deg.C.) and (ii) continuous output power characteristic (the temperature of the DMFC was set to 70 deg.C., and the current density was set to 100 mA/cm²)

(3) Results:

The results of evaluation of characteristics (i) and (ii) will be explained hereinbelow in the order of the reference examples 15 to 28 and the comparison example 2.

### REFERENCE EXAMPLE 15

FIG. 10 shows the voltage-current characteristic of the DMFC. As shown in FIG. 10, the output voltage of the DMFC at a current density of 100 mA/cm² was 450 mV. Referring to FIG. 11 which shows the variation of the output voltage with time during continuous operation at a current density of 100 mA/cm², the output voltage of the DMFC were maintained to be constant even after 5 hour operation and the output voltage was never dropped.

It is noted that the results of voltage-current characteristics of the DMFC and the behaviors of variation of the output voltage with time after continuous operation at a current density of 100 mA/cm² were substantially equal to those shown in FIGS. 10 and 11 as to the reference example 15, even in the reference examples 15 to 28, and accordingly, the figures which show the results and the behaviors in the reference examples 15 to 28 will be omitted. Thus, the output voltage of the DMFC at a current density of 100 mA/cm², and the time of possible continuous power generation at a current density of 100 mA will be shown as to the reference examples 15 to 28.

### REFERENCE EXAMPLE 16

The output voltage of the DMFC at a current density of 100 mA/cm² was 470 mV in view of the result of the voltage-current characteristic of the DMFC. The time of possible continuous operation of the DMFC at a current density of 100 mA/cm² was 8 hours, and the output voltage was maintained constant, and was never dropped.

### REFERENCE EXAMPLE 17

The output voltage of the DMFC at a current density of 100 mA/cm² was 480 mV in view of the result of the voltage-current characteristic of the DMFC. The time of possible continuous operation of the DMFC at a current density of 100 mA/cm² was 8 hours, and the output voltage was maintained constant, and was never dropped.

### REFERENCE EXAMPLE 18

The output voltage of the DMFC at a current density of 100 mA/cm² was 480 mV in view of the result of the voltage-current characteristic of the DMFC. The time of possible continuous operation of the DMFC at a current density of 100 mA/cm² was 16 hours, and the output voltage was maintained constant and was never dropped.

### REFERENCE EXAMPLE 19

The output voltage of the DMFC at a current density of 100 mA/cm² was 480 mV in view of the result of the voltage-current characteristic of the DMFC. The time of possible continuous operation of the DMFC at a current density of 100 mA/cm² was 16 hours, and the output voltage was maintained constant, and was never dropped.

### REFERENCE EXAMPLE 20

The output voltage of the DMFC at a current density of 100 mA/cm² was 480 mV in view of the result of the voltage-current characteristic of the DMFC. The time of possible continuous operation of the DMFC at a current density of 100 mA/cm² was 16 hours, and the output voltage was maintained constant, and was never dropped.

### REFERENCE EXAMPLE 21

The output voltage of the DMFC at a current density of 100 mA/cm² was 530 mV in view of the result of the voltage-current characteristic of the DMFC. The time of possible continuous operation of the DMFC at a current density of 100 mA/cm² was 14.4 hours, and the output voltage was maintained constant, and was never dropped.

### REFERENCE EXAMPLE 22

The output voltage of the DMFC at a current density of 100 mA/cm² was 550 mV in view of the result of the voltage-current characteristic of the DMFC. The time of possible continuous operation of the DMFC at a current density of 100 mA/cm² was 14.4 hours, and the output voltage was maintained constant, and was never dropped.

### REFERENCE EXAMPLE 23

The output voltage of the DMFC at a current density of 100 mA/cm² was 570 mV in view of the result of the voltage-current characteristic of the DMFC. The time of possible continuous operation of the DMFC at a current density of 100 mA/cm² was 14.4 hours, and the output voltage was maintained constant, and was never dropped.

### REFERENCE EXAMPLE 24

The output voltage of the DMFC at a current density of 100 mA/cm² was 570 mV in view of the result of the voltage-current characteristic of the DMFC. The time of possible continuous operation of the DMFC at a current density of 100 mA/cm² was 14.4 hours, and the output voltage was maintained constant, and was never dropped.

### REFERENCE EXAMPLE 25

The output voltage of the DMFC at a current density of 100 mA/cm² was 580 mV in view of the result of the voltage-current characteristic of the DMFC. The time of possible continuous operation of the DMFC at a current density of 100 mA/cm² was 14.4 hours, and the output voltage was maintained constant, and was never dropped.

### REFERENCE EXAMPLE 26

The output voltage of the DMFC at a current density of 100 mA/cm² was 620 mV in view of the result of the voltage-current characteristic of the DMFC. The time of possible continuous operation of the DMFC at a current density of 100 mA/cm² was 14.4 hours, and the output voltage was maintained constant, and was never dropped.

### REFERENCE EXAMPLE 27

The output voltage of the DMFC at a current density of 100 mA/cm² was 640 mV in view of the result of the voltage-current characteristic of the DMFC. The time of possible continuous operation of the DMFC at a current density of 100 mA/cm² was 14.4 hours, and the output voltage was maintained constant, and was never dropped.

### REFERENCE EXAMPLE 28

The output voltage of the DMFC at a current density of 100 mA/cm² was 650 mV in view of the result of the voltage-current characteristic of the DMFC. The time of possible continuous operation of the DMFC at a current density of 100 mA/cm² was 14.4 hours, and the output voltage was maintained constant, and was never dropped.

### COMPARISON EXAMPLE 2

FIG. 12 shows the voltage-current characteristic of the DMFC. As shown, the output voltage of the DMFC at a current density of 100 mA/cm² was 450 mV. Referring to FIG. 13 which shows variation of the output voltage with time after 5 hour power generation at a current density of 100 mA/cm², the output voltage of the DMFC caused such a problem that the output voltage was once dropped since the supply of the methanol aqueous solution as a fuel fed to the anode became unstable due to carbonic acid gas produced after 36 min. or 63 min. elapsed from a start of operation of the fuel power source. Further, after 300 hours elapsed, large gas bubbles of carbonic acid gas were produced so as to hinder the supply of the methanol aqueous solution, resulting in great lowering of the output voltage. Among the results of the tests carried out with the reference examples 1 to 14 and the comparison example 2, (i) the output voltages of the DMFCs at a current density of 100 mA/cm² and (2) times of the possible continuous power generation at a current density of 100 mA/cm² are summarized in Table 2.

TABLE 2

| | | Possibility of | |
|---|---|---|---|
| | Output | 5 hour | Continuous |
| | Voltage | continuous | Operation |
| | (mV) | operation | Time |
| Ref. Ex. 15 | 450 | YES | 5 |
| Ref. EX. 16 | 470 | YES | 8 |
| Ref. Ex. 17 | 480 | YES | ↑ |
| Ref. Ex. 18 | 480 | YES | 16 |
| Ref. Ex. 19 | 480 | YES | ↑ |
| Ref. Ex. 20 | 480 | YES | ↑ |
| Ref. EX. 21 | 530 | YES | 14.4 |
| Ref. Ex. 22 | 550 | YES | ↑ |
| Ref. Ex. 23 | 570 | YES | ↑ |
| Ref. Ex. 24 | 570 | YES | ↑ |
| Ref. Ex. 25 | 580 | YES | ↑ |
| Ref. Ex. 26 | 620 | YES | ↑ |
| Ref. Ex. 27 | 640 | YES | ↑ |
| Ref. Ex. 28 | 650 | YES | ↑ |
| Com. Ex. 2 | 450 | NO | Less than 5 |

Note:
The output voltage was obtained at a current density of 100 mA/cm².

It can be understood from results listed in Table 2 and FIGS. 10 to 13 that the reference examples 15 to 28 exhibit the following technical effects and advantages.

By comparing between the result of the voltage-current characteristic of the DMFC in the reference example 15 shown in FIG. 10 and the result of the voltage-current characteristic of the DMFC in the comparison example 2 shown in FIG. 12, the voltage-current characteristics of both DMFCs were substantially identical with each other, and the output voltage at the current density of 100 mA/cm² of both were 450 mV.

By comparing the relationship between the time of continuous power generation of the DMFC in the reference example 15 shown in FIG. 11 and the output voltage thereof with the relationship between the time of continuous power generation of the fuel cell power source in the comparison example 2 shown in FIG. 13 and the output voltage thereof, the output voltage was stable during 5 hour continuous power generation of the DMFC in the reference example 15 and did never drop. Meanwhile, the output voltage in the comparison example 2 was unstable during 5 hour power generation, and dropped. The reason is such that in the reference example 2, pulsation is applied to the methanol aqueous solution when it is fed to the DMFC so that carbonic acid gas produced in the anode can be smoothly removed from the DMFC, and on the other hand, in the comparison example 2, no pulsation is applied to the methanol aqueous solution when it is fed into the DMFC, and accordingly, carbonic acid gas produced in the anode cannot be smoothly removed from the fuel cell power source. As stated above, the result of comparison between the reference example 15 and the comparison example 2 shows that since the methanol aqueous solution and the water are fed through time-sharing with the use of the solenoid valve so as to reduce the number of liquid feed pumps to one in the fuel cell power source in the reference example 15, in comparison with the comparison example 2 in which three liquid feed pumps are used, the space saving and the weight reduction of the fuel cell power source can be made in the reference example 15. Further, in the fuel cell power source in the reference example 15, since pulsation is applied to the methanol aqueous solution when it is fed to the DMFC, so as to smoothly remove carbonic acid gas produced in the anode, from the DMFC, the power generation can be continued with a stable output voltage (450 mV).

By comparing the result of the voltage-current characteristic of the DMFC in the reference example 16 with the result of the voltage-current characteristic of the DMFC in the reference example 15, the output voltage of the DMFC in the reference example 16 at the current density of 100 mA/cm² is 470 mV which is higher than that in the reference example 15 by about 20 mV. By comparing the relationship between the time of continuous power generation of the DMFC in the reference example 16 and the output voltage thereof with the relationship between the time of continuous power generation of the DMFC in the reference example 15 and the output voltage thereof, the time of continuous power generation of the fuel cell power source with a stable output voltage (470 mV) in the reference example 16 is 8 hours, which is longer than the time (5 hours) of continuous power generation in the reference example 15 by 3 hours. As stated above, the result of comparison between the reference example 16 and the reference example 15 shows that the output voltage of the DMFC at the current density of 100 mA/cm² was higher in the reference example 16 than that in the reference example 15 by about 20 mV, and the time of possible continuous power generation with a stable output voltage is longer in the reference example 16 than that in the reference example 15 by 3 hours, in addition to the advantages which can be obtained in the reference example 15 in comparison with the comparison example 2. This technical effects are due to the hydrophilic process applied to the carbon powder in the anode diffusion layer. That is, with this hydrophilic process, since the anode diffusion layer becomes wettable with respect to the aqueous methanol aqueous solution, the methanol aqueous solution can penetrate into the anode diffusion layer 103 by a larger quantity, and accordingly, the reaction can be promoted, resulting in a high output voltage. Further, with this hydrophilic process, since air bubbles of carbonic acid gas produced in the anode can be prevented from growing into a larger size, but can be discharged from the anode diffusion layer 105 with a fine size as it is, the supply of the methanol aqueous solution to the anode can be smoothly made, thereby it is possible to carry out long continuous power generation with a stable voltage.

By comparing the result of the voltage-current characteristic of the DMFC in the reference example 17 with the result of the voltage-current characteristic of the DMFC in the reference example 16, the output voltage of the DMFC in the reference example 17 at the current density of 100 mA/cm² is 480 mV which is higher than that in the reference example 16 by about 10 mV. Then, the relationship between the time of continuous power generation of the DMFC in the reference example 17 and the output voltage thereof is idential with the relationship between the time of continuous power generation of the DMFC in the reference example 16 and the output voltage thereof. The result of comparison between the reference example 17 and the reference example 16 shows that the output voltage of the DMFC at the current density of 100 mA/cm² was higher in the reference example 17 than that in the reference example 16 by about 10 mV, in addition to the advantages which can be obtained in the reference example 16 in comparison with the reference example 15. This technical effects are due to the hydrophilic process applied further in the reference example 17 to the carbon cloth carrier of the anode diffusion layer used in the reference example 16. That is, with this hydrophilic process, since the anode diffusion layer becomes wettable with respect to the aqueous methanol aqueous solution, the methanol aqueous solution can penetrate into the anode diffusion layer 103 by a larger quantity, and accordingly, the reaction can be promoted, resulting in a high output voltage. Further, with this hydrophilic process, since air bubbles of carbonic acid gas produced in the anode can be prevented from growing into a larger size, but can be discharged from the anode diffusion layer 105 with a fine size as it is, the supply of the methanol aqueous solution fed to the anode can be smoothly made, thereby it is possible to carry out long continuous power generation with a stable voltage.

By comparing the result of the voltage-current characteristic of the DMFC in the reference example 18 with the result of the voltage-current characteristic of the DMFC in the reference example 15, the output voltage of the DMFC in the reference example 18 at the current density of 100 mA/cm² is 480 mV which is higher than that in the reference example 15 by about 30 mV. The difference between the reference example 18 and the reference example 15 is such that a hydrocarbon group electrolyte is used for the electrolyte membrane and the binder in the reference example 18 but a fluorine group electrolyte is used for the electrolyte membrane and the binder in the reference example 15. Thus the ion conductivity of the hydrocarbon group electrolyte used in the is higher in the reference example 15 than the fluorine group electrolyte used in the reference example 15. That is, the internal resistance of the DMFC is lower. By comparing the relationship between the time of continuous power generation of the DMFC in the reference example 18 and the output voltage thereof with the relationship between the time of continuous power generation of the DMFC in the reference example 15 and the output voltage thereof, the time of possible continuous power generation of the fuel cell power source with a stable output voltage in the embodiment 18 is 16 hours, which is not less than two times as long as that (5 hours) in the reference example 15.

Thus, the result of comparison between the reference example 18 and the reference example 15 shows such a technical effect that the time of possible continuous power generation with a stable output voltage is longer than that in the reference example 15 by not less than two times. This technical effect is caused by replacing the binder between the solid polymer electrolyte membrane and the anode with the hydrocarbon group electrolyte membrane by way of which less methanol crosses over, in comparison with the fluorine group electrolyte membrane used in the reference example 15. The smaller the quantity of the methanol crossing over the solid polymer electrolyte membrane, the smaller the variation of the concentration of the methanol in the methanol aqueous solution, it is possible to enhance the stability of the fuel cell power source and to contribute to enhancement of the availability of the fuel.

By comparing the result of the voltage-current characteristic of the DMFC in the reference example 19 with the result of the voltage-current characteristic of the DMFC in the reference example 18, the output voltage of the DMFC in the reference example 19 at the current density of 100 mA/cm² is 480 mV which is equal to that in the reference example 18. Then, by comparing the relationship between the time of continuous power generation of the DMFC in the reference example 19 and the output voltage thereof with the relationship between the time of continuous power generation of the DMFC in the reference example 18 and the output voltage thereof, the time of possible continuous power generation of the fuel cell power source with a stable output voltage in the reference example 19 is equal to that in the reference example 18. The result of comparison between the reference example 19 and the reference example 18 shows that the reference example 19 can offer technical effects the same as that in the reference example 18 with only using the time-sharing type piezoelectric liquid feed pump but without using the solenoid valve for adjusting the concentration of the methanol aqueous solution fed to the DMFC.

By comparing the result of the voltage-current characteristic of the DMFC in the reference example 20 with the result of the voltage-current characteristic of the DMFC in the reference example 19, the output voltage of the DMFC in the reference example 20 at the current density of 100 mA/cm² is 480 mV which is equal to that in the reference example 19.

Then, by comparing the relationship between the time of continuous power generation of the DMFC in the reference example 20 and the output voltage thereof with the relationship between the time of continuous power generation of the DMFC in the reference example 19 and the output voltage thereof, the time of possible continuous power generation of the fuel cell power source with a stable output voltage in the reference example 20 is equal to that in the reference example 19. As stated above, the thus result of comparison between the reference example 20 and the reference example 19 shows that the reference example 19 can offer technical effects similar to those in the reference example 15 although the liquid feed is maid by the time-sharing type piezoelectric liquid feed pump having the left and right partition wall chambers with different volumes without using the solenoid valve for adjusting the concentration of the methanol aqueous solution fed to the DMFC.

By comparing the result of the voltage-current characteristic of the DMFC in the reference example 21 with the result of the voltage-current characteristic of the DMFC in the reference example 19, the output voltage of the DMFC in the reference example 21 at the current density of 100 mA/cm² is 530 mV which is higher than that in the reference example 19 by about 50 mV.

Then, by comparing the relationship between the time of continuous power generation of the DMFC in the reference example 21 and the output voltage thereof with the relationship between the time of continuous power generation of the DMFC in the reference example 19 and the output voltage thereof, the time of possible continuous power generation of the fuel cell power source with a stable output voltage in the reference example 21 is 14.4 hours which is slightly shorter than that in the reference example 19. As stated above, the result of comparison between the reference example 21 and the reference example 19 shows that the output voltage of the DMFC at the current density of 100 mA/cm² was higher in the reference example 21 than that in the reference example 19 by about 50 mV, and although the time of possible continuous power generation with a stable output voltage is slightly shorter than that in the reference example 19, technical effects substantially the same as those in the reference example 19 can be obtained, in addition to the advantages which can be obtained in the reference example 19 in comparison with the reference examples 15 to 18. This technical effects are caused by such a fact that the thickness of the anode catalyst layer is increased from 80 μm to 150 μm, but the thickness of the cathode catalyst layer 104 is decreased from 50 μm to 25 μm. By increasing the thickness of the anode catalyst layer 103, the area through which the methanol aqueous solution makes contact with the anode catalyst layer 103 is increased, resulting in promotion of the reaction between the methanol and the water in the anode catalyst layer 103, thereby it is possible to increase the output voltage. Further, the promotion of the reaction due to an increase in the contact area between the methanol aqueous solution and the anode catalyst layer can contribute to the enhancement of the availability of the fuel. It is noted, the reason why the thickness of the cathode catalyst layer 104 is decreased is such that the air or oxygen is effectively consumed, and the quantity of the cathode catalyst is decreased to a value which can prevent the output power of the fuel cell from lowering, in order to reduce the total quantity of platinum for reducing the total cost, in view of prevention of increase of the thickness of the DMFC and expensive cost of the catalyst such as platinum. In particular, the decease of the thickness of the cathode causes efficient consumption of oxygen so as to effectively enhance the performance of the cell.

By comparing the result of the voltage-current characteristic of the DMFC in the reference example 22 with the result of the voltage-current characteristic of the DMFC in the reference example 21, the output voltage of the DMFC in the reference example 22 at the current density of 100 mA/cm² is 550 mV which is higher than that in the reference example 21 by about 20 mV. Then, by comparing the relationship between the time of continuous power generation of the DMFC in the reference example 22 and the output voltage thereof with the relationship between the time of continuous power generation of the DMFC in the reference example 21 and the output voltage thereof, the time of possible continuous power generation of the fuel cell power source with a stable output voltage in the reference example 22 is equal to that in the reference example 21.

Thus the result of comparison between the reference example 22 and the reference example 21 shows that the output voltage of the DMFC at the current density of 100 mA/cm² is higher in the reference example 22 than that in the reference example 21 by about 20 mV, in addition to the technical effects which can be obtained by the reference example 21, in comparison with the reference example 19. The reason why the output voltage can be increased, is such that the carbon powder in the anode diffusion layer is subjected to the hydrophilic process. That is, since the anode diffusion layer becomes wettable with respect to the methanol aqueous solution, the methanol aqueous solution smoothly penetrates into the anode catalyst layer 103 by a larger quantity. Thus, the reaction between the methanol and the water is promoted in the anode catalyst layer 103, and accordingly, the output voltage can be increased.

By comparing the result of the voltage-current characteristic of the DMFC in the reference example 23 with the result of the voltage-current characteristic of the DMFC in the reference example 22, the output voltage of the DMFC in the reference example 23 at the current density of 100 mA/cm² is 570 mV which is higher than that in the reference example 22 by about 20 mV. Then, by comparing the relationship between the time of continuous power generation of the DMFC in the reference example 23 and the output voltage thereof with the relationship between the time of continuous power generation of the DMFC in the reference example 22 and the output voltage thereof, the time of possible continuous power generation of the fuel cell power source with a stable output voltage in the reference example 23 is equal to that in the reference example 22. As stated above, the result of comparison between the reference example 23 and the reference example 22 shows that the output voltage of the DMFC at the current density of 100 mA/cm² is higher in the reference example 23 than that in the reference example 22 by about 20 mV. The reason why the output voltage can be increased is such that the carbon cloth carrier of the anode diffusion layer subjected to the hydrophilic process is wettable with respect to the methanol aqueous solution which can relatively smoothly penetrate by a larger quantity into the anode catalyst layer.

By comparing the result of the voltage-current characteristic of the DMFC in the reference example 24 with the result of the voltage-current characteristic of the DMFC in the reference example 22, the output voltage of the DMFC in the reference example 24 at the current density of 100 mA/cm² is 570 mV which is higher that in the reference example 22 by 20 mV.

Then, by comparing the relationship between the time of continuous power generation of the DMFC in the reference example 24 and the output voltage thereof with the relationship between the time of continuous power generation of the DMFC in the reference example 22 and the output voltage thereof, the time of possible continuous power generation of the fuel cell power source with a stable output voltage in the reference example 10 is equal to that in the reference example 22. As sated above, the result of comparison between the reference example 24 and the reference example 22 shows that the output voltage can be increased due to such a fact that carbon paper is used in the anode diffusion layer, instead of the carbon cloth. This fact shows that the carbon paper is excellent for the carrier in the diffusion layer, in comparison with the carbon cloth.

By comparing the result of the voltage-current characteristic of the DMFC in the reference example 24 with the result of the voltage-current characteristic of the DMFC in the reference example 24, the output voltage of the DMFC in the reference example 25 at the current density of 100 mA/cm² is 580 mV which is higher than that in the reference example 24 by about 10 mV. Then, by comparing the relationship between the time of continuous power generation of the DMFC in the reference example 25 and the output voltage thereof with the relationship between the time of continuous power generation of the DMFC in the reference example 24 and the output voltage thereof, the time of possible continuous power generation of the fuel cell power source with a stable output voltage in the reference example 25 is equal to that in the reference example 24.

Thus the result of comparison between the reference example 25 and the reference example 24 shows that the output voltage of the DMFC at the current density of 100 mA/cm² is higher in the reference example 25 than that in the reference example 24 by about 10 mV, in addition to the technical effects obtained in the reference example 24 in comparison with the reference example 23. The reason why the technical effect, that is, the output voltage can be increased, is such that the material of the binder of the cathode diffusion layer is changed from the fluororesin group electrolyte membrane into the hydrocarbon group electrolyte membrane so as to further increase the ion conductivity, and accordingly, the internal resistance can be decreased, thereby it is possible to increase the output voltage.

By comparing the result of the voltage-current characteristic of the DMFC in the reference example 26 with the result of the voltage-current characteristic of the DMFC in the reference example 25, the output voltage of the DMFC in the reference example 26 at the current density of 100 mA/cm² is 620 mV which is higher than that in the reference example 25 by about 50 mV. Then, by comparing the relationship between the time of continuous power generation of the DMFC in the reference example 26 and the output voltage thereof with the relationship between the time of continuous power generation of the DMFC in the reference example 25 and the output voltage thereof, the time of possible continuous power generation of the fuel cell power source with a stable output voltage in the reference example 26 is equal to that in the reference example 25.

As stated above, the result of comparison between the reference example 26 and the reference example 25 shows that the output voltage of the DMFC at the current density of 100 mA/cm² is higher in the reference example 26 than that in the reference example 25 by about 40 mV, in addition to the technical effects obtained in the reference example 25 in comparison with the reference example 24. This technical effect is due to that by increasing the thickness of the anode catalyst layer 103 from 150 to 200 μm, the contact area between the methanol aqueous solution and the anode catalyst is further increased, resulting in promotion of the reaction between the methanol and the water in the anode catalyst layer 103, thereby it is possible to increase the output voltage. Further, by decreasing the thickness of the cathode catalyst layer from 25 to 15 μm, the availability of oxygen can be enhanced so as to contribute to the enhance of the output power and the output voltage.

By comparing the result of the voltage-current characteristic of the DMFC in the reference example 27 with the result of the voltage-current characteristic of the DMFC in the reference example 25, the output voltage of the DMFC in the reference example 27 at the current density of 100 mA/cm² is 640 mV which is higher than that in the reference example 25 by about 60 mV.

Then, by comparing the relationship between the time of continuous power generation of the DMFC in the reference example 27 and the output voltage thereof with the relationship between the time of continuous power generation of the DMFC in the reference example 25 and the output voltage thereof, the time of possible continuous power generation of the fuel cell power source with a stable output voltage in the reference example 27 is equal to that in the reference example 25. As stated above, the result of comparison between the reference example 27 and the reference example 25 shows that the output voltage of the DMFC at the current density of 100 mA/cm² is higher in the reference example 27 than that in the reference example 25 by about 60 mV, in addition to the technical effects obtained in the reference example 25 in comparison with the reference example 24. This technical effect is such that although the thickness of the anode catalyst layer is decreased from 150 to 100 μm so as to decrease the contact area between the methanol aqueous solution and the anode catalyst layer, the possibility of the contact between the methanol aqueous solution and anode catalyst can be increased by subjecting the carbon carrier of the anode catalyst layer 103 to the hydrophilic process, and oxygen can diffuse inward of the cathode so as to enhance the availability of the oxygen by decreasing the thickness of the cathode catalyst layer 104 from 25 to 10 μm, thereby it is possible to increase the output voltage.

By comparing the result of the voltage-current characteristic of the DMFC in the reference example 28 with the result of the voltage-current characteristic of the DMFC in the reference example 27, the output voltage of the DMFC in the reference example 28 at the current density of 100 mA/cm² is 650 mV which is higher than that in the reference example 27 by about 10 mV. Then, by comparing the relationship between the time of continuous power generation of the DMFC in the reference example 28 and the output voltage thereof with the relationship between the time of continuous power generation of the DMFC in the reference example 27 and the output voltage thereof, the time of possible continuous power generation of the fuel cell power source with a stable output voltage in the reference example 28 is equal to that in the reference example 27. As stated above, the result of comparison between the reference example 28 and the reference example 27 shows that the output voltage of the DMFC at the current density of 100 mA/cm² is higher in the reference example 28 than that in the reference example 27 by about 10 mV in addition to the technical effects obtained by the reference example 27 in comparison with the reference example 26. In particular, the reduction of the thickness of the cathode catalyst layer can enhance the availability of oxygen, thereby it is possible to effectively increase the output power.

### APPLICATION EXAMPLES

### APPLICATION EXAMPLE 1

Referring to FIG. 14 which schematically shows a configuration of a fuel cell power source used in a note type personal computer and a high concentration methanol aqueous solution container, the fuel cell power source stated in the reference example 12 was used as the fuel cell power source 501 in this note type personal computer 500, and further, as the high concentration methanol aqueous solution container, a fuel cartridge 502 which was of a replaceable cartridge type so that a high concentration methanol aqueous solution container emptied after use could be replaced with a filled container was used. This note type personal computer 200 could be continuously operated at an averaged output power of 12 W for 8 hours.

### APPLICATION EXAMPLE 2

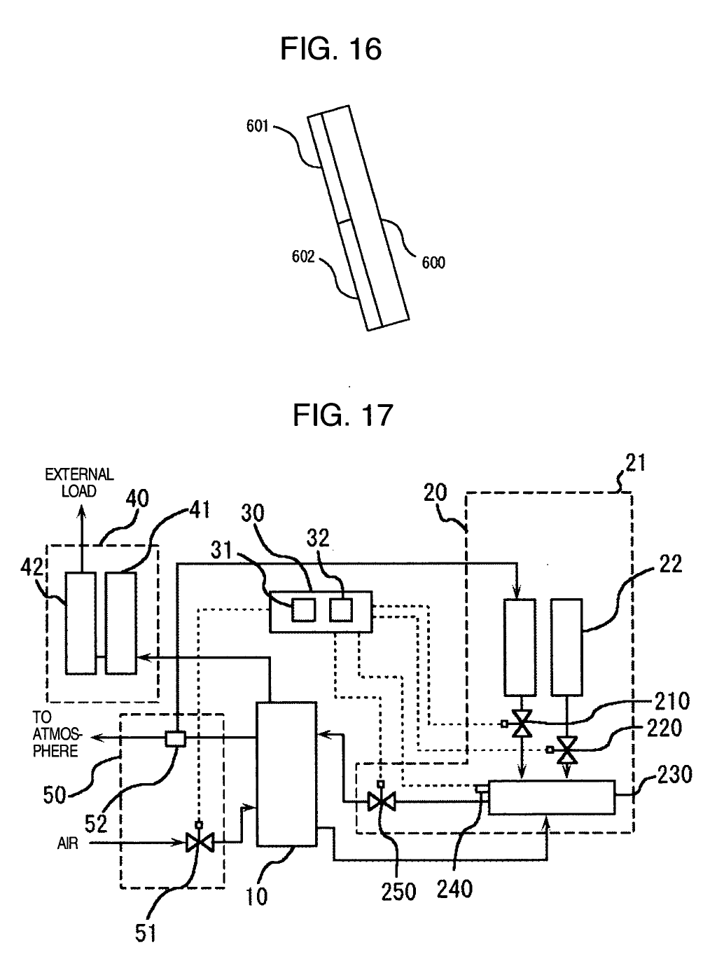

FIGS. 15 and 16 show a PDA (Personal Digital Assistant). In particular, FIG. 16 is a schematic perspective view illustrating the PDA (Personal Data Assistant).

Referring to FIG. 16 schematically show the configuration of a fuel cell power source 601 and a high concentration methanol aqueous solution container in this PDA (personal data Assistant). The fuel cell power source stated in the reference example 13 was used as the fuel cell power source 601 in the PDA 600. Further, as the high concentration methanol aqueous solution container, there was used a fuel cartridge 602 which is a replaceable cartridge type so that a high concentration methanol aqueous solution container emptied after use could be replaced with a filled container. This PDA (Personal Data Assistance) could be continuously operated for eight hours. Further, a mobile telephone (which is not shown) using the fuel cell power source stated in the reference example 13 could be continuously operated for 50 hours. In this case, when the output power of the fuel cell power source was dropped, vibration was exerted to the mobile telephone through a vibration function incorporated in a manner mode system in this mobile telephone so as to recover the output power of the fuel cell power source to a stable value. This is because bubbles of carbonic acid gas produced in the anode could be discharged with a fine size as it was due to the vibration without growing to large size bubbles, thereby the fuel could be uniformly distributed in the anode.

There have been following problems inherent to a fuel cell power source using a liquid fuel:

(1) In a fuel cell power source using a conventional liquid fuel through circulation, since it uses a concentration control mechanism detecting a concentration of the liquid fuel, for maintaining the fuel at a predetermined concentration, a plurality of pumps including a pump for feeding the high concentration liquid fuel and a pump for feeding water are required. The use of the plurality of pumps causes the space within a fuel cell power source occupied by accessories including the pumps to become larger, and as a result, the fuel cell power source itself becomes large-sized;

(2) Unless carbonic gas bubbles produced in the anode through the reaction exhibited by the chemical formula (1) is smoothly discharged from the anode, a liquid fuel such as methanol cannot be sufficiently fed to the anode, thereby the output power of the cell becomes stable or is dropped.

(3) Since a liquid fuel such as methanol fed to the anode cannot sufficiently penetrate into the anode diffusion layer, the output power and the availability of the fuel are lowered;

(4) Since a liquid fuel such as methanol fed to the anode do not smoothly react, the output power and the availability of the fuel are lowered; and

(5) Since no oxidation of protons are caused unless oxygen fed to the cathode is fully distributed in the cathode catalyst layer, the output power and the availability of the fuel are lowered.

The above-mentioned the problems (2) to (5) have been caused common to both dilution and circulation type stacked fuel cell power source and a natural exhalation panel (planer) type fuel cell power source.

The technical effects which can be obtained by the embodiments of the present invention, that is, the reference examples 1 to 28 and the application examples 1 to 2 are summarized as follows:

(1) Since the provision of a plurality of pumps for maintaining the concentration of a liquid fuel such as a methanol at a predetermined value, is not required, there can be provided a fuel cell power source which can be small-sized and light-weight, a method of operating thereof and a portable electronic equipment;

(2) Further, carbonic acid gas can be smoothly discharged from the anode so as to uniformly distribute a liquid fuel such as methanol in the anode, there can be provided a fuel cell power source which can increase an output power, a method of operating thereof, and a portable electronic equipment using thereof.

(3) Further, since liquid fuel such as methanol fed to the anode can penetrate sufficiently into the anode diffusion layer, a fuel cell power source which can increase an output power and can enhance the availability of fuel, and accordingly, there can be provided a method of operating thereof and a portable electronic equipment using thereof;

(4) Further, since the thickness of the anode catalyst layer is increased so as to increase the quantity of catalyst for carrying out the reaction between the methanol and the water, the reaction of a liquid fuel such as methanol is promoted, and accordingly, a fuel cell power source which can increase an output power and can enhance the availability of fuel, and accordingly, there can be provided a fuel cell power source which can increase an output power, a method of operating thereof and a portable electronic equipment using thereof;

(5) Further, since the thickness of the cathode catalyst layer is decreased so that oxygen is fully diffused into the cathode catalyst layer, the availability of the oxygen can be enhanced, and accordingly, there can be provided a fuel cell power source which can increase an output power, and a method of operating thereof and a portable electronic equipment using thereof;

(6) Further, since carbonic gas produced through the reaction of the fuel cell power source can be smoothly discharged always, there can be provided a fuel cell power source which can operate for a long time, a method of operating thereof and a portable electronic equipment using thereof; and

(7) Further, since a portable electronic equipment using the fuel cell power source or the method of operating thereof can be operated for a long time, it can be directly incorporated as a power source in a portable electronic equipment such as a mobile telephone, a portable personal computer or a portable audio/visual equipment which requires a secondary battery or a battery charger, with no necessity of a secondary battery or a battery charge.

An object of the embodiments, according to the present invention, is to provide a fuel cell power source without the necessity of a plurality of pumps, which can be small-sized and light-weight, a method of operating thereof and a portable electronic equipment using thereof. Further, another object of the embodiments, according to the present invention, is to provide a fuel cell power source which can smoothly discharge carbonic acid gas produced through the reaction of the fuel cell from an anode so as to increase the output power of the cell, a method of operating thereof and a portable electronic equipment using thereof.

Further, another object of the embodiments, according to the present invention, is to provide a fuel cell power source in which a liquid fuel such as methanol fed to the fuel cell can sufficiently penetrate into an anode diffusion layer, which can therefore increase the output power and to enhance the availability of the fuel, a method of operating thereof and a portable electronic equipment using thereof.

Further, another object of the embodiments, according to the present invention, is to provide a fuel cell power source in which the reaction of a liquid fuel such as methanol fed to anode is promoted so as to increase the output power and to enhance the availability of the fuel, and a method of operating thereof and a portable electronic equipment using thereof.

Further, another object of the embodiments, according to the present invention, is to provide a fuel cell power source in which carbonic acid produced through the reaction of the fuel cell can be smoothly discharged from an anode, and which can be therefore continuously operated for a long time, and a method of operating thereof and a portable electronic equipment using thereof. That is, carbonic acid produced through the reaction of the fuel cell can be smoothly discharged from the anode, thereby it is possible to continuously operated the fuel cell power source with a stable output power. Further, the liquid fuel such as methanol fed to the cell can sufficiently penetrate into the anode diffusion layer, thereby it is possible to increase the output power of the fuel cell power source and to enhance the availability of the fuel. Moreover, the reaction of the liquid fuel such as methanol fed to the anode can be promoted, thereby it is possible to increase the output power of the fuel cell power source and to enhance the availability of the fuel.

It should be further understood by those skilled in the art that although the foregoing description has been made on embodiments of the invention, the invention is not limited thereto and various changes and modifications may be made without departing from the spirit of the invention and the scope of the appended claims.

1. A fuel cell power source comprising a fuel cell part including an anode, a cathode arranged so as to be opposed to the anode, a solid polymer electrolyte membrane interposed between the anode and the cathode, for power generation, and a liquid fuel supply part for feeding a liquid fuel and water into the fuel cell part, wherein the liquid fuel supply part includes a means for feeding the fuel and the water to the anode by a single pump through time-sharing.

2. A fuel cell power source as set forth in claim 1, wherein the liquid fuel supply part includes a means for feeding the liquid fuel and the water into the anode by a single pump through time-sharing, by using a solenoid valve.

3. A fuel cell power source as set forth in claim 1, wherein the liquid fuel supply part includes a means for feeding the liquid fuel and the water into the anode through time-sharing with the use of a piezoelectric pump.

4. A fuel cell power source as set forth in claim 1, wherein the liquid fuel supply part includes a means for feeding the liquid fuel and the water into the anode through time-sharing by a single plunger pump.

5. A fuel cell power source as set forth in claim 1, wherein
the anode includes an anode catalyst layer arranged at a surface thereof on the side which makes contact with the solid polymer electrolyte membrane, an anode diffusion layer arranged at a surface of the anode catalyst layer on the side which does not make contact with the solid polymer electrolyte membrane, and a liquid fuel passage board arranged outside of the anode diffusion layer,
the cathode includes a cathode catalyst layer arranged at a surface thereof on the side which makes contact with the solid polymer electrolyte membrane, a cathode diffusion layer at a surface of the cathode catalyst layer on the side which does not make contact with the solid polymer electrolyte membrane, and an oxidant gas passage board arranged outside of the cathode diffusion layer,
and further, the anode diffusion layer is subjected to a hydrophilic process.

6. A fuel cell power source as set forth in claim 5, wherein the anode catalyst layer is formed of a carbon carrier which is subjected to a hydrophilic process.

7. A fuel cell power source as set forth in claim 5, wherein the solid polymer electrolyte membrane is a sulfomethylpolyether sulfonhydrocarbon group electrolyte membrane, and a binder used in the anode catalyst layer is a sulfomethylpolyether sulfonhydrocarbon group electrolyte.

8. A fuel cell power source as set forth in claim 5, wherein the solid polymer electrolyte membrane is an alkylene sulfonic acid group introduced-aromatic hydrogen carbon group electrolyte membrane, and a binder used in the anode catalyst layer is made of an alkylene sulfonic acid group introduced-aromatic hydrocarbon group electrolyte.

9. A fuel cell power source as set forth in claim 5, wherein the anode catalyst layer has a thickness which is larger than that of the cathode catalyst layer.

10. A fuel cell power source as set forth in claim 5, wherein a binder used in the anode catalyst layer is a sulfomethylpolyether sulfonhydrocarbon group electrolyte.

11. A fuel cell power source as set forth in claim 5, wherein a binder used in the cathode catalyst layer is made of an alkylene sulfonic acid group introduced-aromatic hydrocarbon group electrolyte.

12. A method of operating a fuel cell power source composed of a fuel cell power source comprising a fuel cell part including an anode, a cathode arranged so as to be opposed to the anode, a solid polymer electrolyte membrane interposed between the anode and the cathode, for power generation, and a liquid fuel supply part for feeding a liquid fuel and water into the fuel cell part, wherein the liquid fuel and the water which are fed to the liquid fuel supply part is fed through time-sharing by a single pump.

13. A method of operating a fuel cell power source as set forth in claim 12, wherein the liquid fuel and the water fed to the anode is fed by the single pump through time-sharing with the use of a solenoid valve.

14. A method of operating a fuel cell power source as set forth in claim 12, wherein the liquid fuel and the water are fed to the anode through time-sharing with the use of a piezoelectric pump.

15. A method of operating a fuel cell power source as set forth in claim 12, wherein the liquid fuel and the water are fed to the anode through time-sharing with the use of a plunger pump.

16. A method of operating a fuel cell power source as set forth in claim 12, wherein
the anode includes an anode catalyst layer arranged at a surface thereof on the side which makes contact with the solid polymer electrolyte membrane, an anode diffusion layer arranged at a surface of the anode catalyst layer on the side which does not make contact with the solid polymer electrolyte membrane, and a liquid fuel passage board arranged outside of the anode diffusion layer,
the cathode includes a cathode catalyst layer arranged at a surface thereof on the side which makes contact with the solid polymer electrolyte membrane, a cathode diffusion layer at a surface of the cathode catalyst layer on the side which does not make contact with the solid polymer electrolyte membrane, and an oxidant gas passage board arranged outside of the cathode diffusion layer,
and further, the anode diffusion layer is subjected to a hydrophilic process.

17. A method of operating a fuel cell power source as set forth in claim 16, wherein the anode catalyst layer is formed of a carbon carrier which is subjected to a hydrophilic process.

18. A method of operating a fuel cell power source as set forth in claim 16, wherein the solid polymer electrolyte membrane is a sulfomethylpolyether sulfonhydrocarbon group electrolyte membrane, and a binder used in the anode catalyst layer is a sulfomethylpolyether sulfonhydrocarbon group electrolyte.

19. A method of operating a fuel cell power source as set forth in claim 16, wherein the solid polymer electrolyte membrane is an alkylene sulfonic acid group introduced-aromatic hydrogen carbon group electrolyte membrane, and a binder used in the anode catalyst layer is made of an alkylene sulfonic acid group introduced-aromatic hydrocarbon group electrolyte.

20. A portable electronic equipment using a fuel cell power source as set forth in claim 1.

21. A portable electronic equipment as set forth in claim 20, wherein the portable electronic equipment is a note-type personal computer.

22. A portable electronic equipment as set forth in claim 20, wherein the portable electronic equipment is a personal data assistant.

23. A portable electronic equipment as set forth in claim 20, wherein said portable electronic equipment is a mobile telephone.
